(19) United States
(12) Patent Application Publication
(10) Pub. No.: US 2026/0138367 A1
(43) Pub. Date: May 21, 2026

(54) DEVICES, SYSTEMS, AND METHODS FOR PRINTHEAD CLEANING

(71) Applicant: Canon U.S.A., Inc., Melville, NY (US)

(72) Inventor: Jeffrey David Kane, Boynton Beach, FL (US)

(21) Appl. No.: 19/448,641

(22) Filed: Jan. 14, 2026

Related U.S. Application Data
(63) Continuation of application No. PCT/US2023/072166, filed on Aug. 14, 2023.

(51) Int. Cl. B41J 2/165; B41J 29/00

(52) U.S. Cl. CPC B41J 2/16552; B41J 2/1652; B41J 29/00; B41J 2002/16594

(57) ABSTRACT

Some embodiments of a system comprise a cleaning-fluid-supply reservoir that is configured to store cleaning fluid; one or more cleaning-fluid-supply conduits that are configured to convey cleaning fluid from the console to a printhead; a first pump that is configured to supply cleaning fluid from the cleaning-fluid-supply reservoir to the one or more cleaning-fluid-supply conduits; a cleaning-fluid-collection reservoir; a fluid collector, wherein the fluid collector is detached from the cleaning-fluid-collection reservoir and is moveable independent of the cleaning-fluid-collection reservoir; a cleaning-fluid return conduit that is configured to convey liquid from the fluid collector to the cleaning-fluid-collection reservoir; one or more printhead-communication cables that are configured to connect to a printhead and supply electrical signals to the printhead; one or more memories; and one or more processors that are in communication with the one or more memories.

### CROSS-REFERENCE TO RELATED APPLICATIONS

This application is a continuation of PCT Application No. PCT/US2023/072166,

which was filed on Aug. 14, 2023 and which is incorporated herein by reference in its entirety.

### BACKGROUND

### Technical Field

The present disclosure generally concerns devices, systems, and methods for cleaning printheads.

### Background

The printheads of inkjet printers (e.g., drop-on-demand inkjet printers) may include hundreds, thousands, or tens of thousands of nozzles. Also, each nozzle may have a respective ink chamber, and each nozzle may have a respective piezo-electric actuator or a respective heater element. When a charge is applied to a piezo-electric actuator, the piezo-electric actuator changes shape, and the change of shape forces ink from the ink chamber though the nozzle. When a charge is applied to a heater element, the heater element heats the ink in the ink chamber, which vaporizes some of the ink and creates a bubble that forces some of the ink though the nozzle.

The printing process exposes printheads to air, which can cause ink to dry on the nozzles when ink is not being delivered to a print medium (e.g., paper). Other factors that affect the functioning of the nozzles include heat, dust, humidity, the type of print medium, the speed at which the printer moves the print medium past the nozzles, and contact between the printhead and the print medium.

Thus, with use and with the passage of time, ink, dust, and paper fibers may be deposited on the printhead, and some nozzles may become clogged. Also, the piezo-electric actuators, the heater elements, and the other electronics in the printhead may degrade with use and with the passage of time, which may decrease the performance of the printhead (e.g., reduce print quality).

### SUMMARY

Some embodiments of a printhead-cleaning system comprise a cleaning-fluid-supply reservoir that is configured to store cleaning fluid; one or more cleaning-fluid-supply conduits that are configured to connect to the cleaning-fluid-supply reservoir, connect to a printhead, and convey cleaning fluid from the console to the printhead; a first pump that is configured to supply cleaning fluid from the cleaning-fluid-supply reservoir to the one or more cleaning-fluid-supply conduits; a cleaning-fluid-collection reservoir; a fluid collector, wherein the fluid collector is detached from the cleaning-fluid-collection reservoir and is moveable independent of the cleaning-fluid-collection reservoir; a cleaning-fluid return conduit that is configured to connect to the fluid collector and the cleaning-fluid-collection reservoir and that is configured to convey liquid from the fluid collector to the cleaning-fluid-collection reservoir; one or more printhead-communication cables that are configured to connect to a printhead and supply electrical signals to the printhead; one or more memories; and one or more processors that are in communication with the one or more memories. The one or more processors cooperate with the one or more memories to cause the printhead-cleaning system to perform operations including supplying cleaning fluid from the cleaning-fluid-supply reservoir, through the one or more cleaning-fluid-supply conduits, to the printhead, and while supplying the cleaning fluid to the printhead, sending one or more signals to the printhead, through the one or more printhead-communication cables, to activate one or more nozzles of the printhead.

Some embodiments of a method comprise positioning a fluid collector below a printhead that is installed in a printer; coupling one or more printhead-communication cables to the printhead; coupling one or more fluid-supply conduits to the printhead; and while the printhead is installed in the printer, supplying cleaning fluid to the printhead via the one or more fluid-supply conduits, and sending one or more signals to the printhead, through the one or more printhead-communication cables, to activate one or more nozzles of the printhead while supplying the cleaning fluid to the printhead, wherein the nozzles, when activated while cleaning fluid is supplied to the printhead, eject cleaning fluid into the fluid collector.

### BRIEF DESCRIPTION OF THE DRAWINGS

FIG. 1 is a perspective view of an example embodiment of a printhead-cleaning system.

FIG. 2 is a schematic illustration of the printhead-cleaning system when setup to clean a printhead.

FIG. 3 is a schematic illustration of an example embodiment of a console.

FIG. 4 illustrates an example embodiment of an operational flow for performing maintenance on a printhead.

FIG. 5 illustrates an example embodiment of an operational flow for performing maintenance on a printhead.

FIG. 6 illustrates an example embodiment of an operational flow for activating nozzles according to a firing plan.

FIG. 7 illustrates an example embodiment of an operational flow for activating nozzles according to a firing plan.

FIG. 8 illustrates an example embodiment of an operational flow for performing maintenance on a printhead.

FIG. 9 illustrates an example embodiment of an operational flow for performing maintenance on a printhead.

FIG. 10A illustrates an example embodiment of an operational flow for performing an electrical test on a printhead.

FIG. 10B illustrates an example embodiment of an operational flow for obtaining baseline measurements of a printhead.

FIG. 11 illustrates an example embodiment of an operational flow for performing maintenance on a printhead.

FIG. 12 illustrates an example embodiment of an operational flow for executing a maintenance procedure on a printhead.

FIG. 13 illustrates an example embodiment of an operational flow that can replace blocks B1245-B1267 in FIG. 12.

FIG. 14 illustrates an example embodiment of an operational flow for executing a maintenance procedure on a printhead.

FIG. 15 is a schematic illustration of an example embodiment of a console-control device.

FIG. 16 is a schematic illustration of an example embodiment of a printhead-control device.

### DETAILED DESCRIPTION

The following paragraphs describe certain explanatory embodiments. Other embodiments may include alternatives, equivalents, and modifications. Additionally, the explanatory embodiments may include several novel features, and a particular feature may not be essential to some embodiments of the devices, systems, and methods that are described herein. Furthermore, some embodiments include features from two or more of the following explanatory embodiments. Thus, features from various embodiments may be combined and substituted as appropriate.

Also, as used herein, the conjunction “or” generally refers to an inclusive “or,” although “or” may refer to an exclusive “or” if expressly indicated or if the context indicates that the “or” must be an exclusive “or.”

Moreover, as used herein, the terms “first,” “second,” and so on, do not necessarily denote any ordinal, sequential, or priority relation and may be used to more clearly distinguish one member, operation, element, group, collection, set, region, section, etc. from another without expressing any ordinal, sequential, or priority relation. Thus, a first member, operation, element, group, collection, set, region, section, etc. discussed below could be termed a second member, operation, element, group, collection, set, region, section, etc. without departing from the teachings herein.

And in the following description and in the drawings, like reference numbers designate identical or corresponding members throughout the several views.

Additionally, in this description and the drawings, an alphabetic suffix on a reference number may be used to indicate a specific instance of the feature identified by the reference number. For example, the fluid conduits in a group of conduits may be identified with the reference number 111 when a particular fluid-supply conduit is not being distinguished. However, 111A may be used to identify a specific fluid-supply conduit when the specific fluid-supply conduit is being distinguished from the rest of the fluid-supply conduits 111.

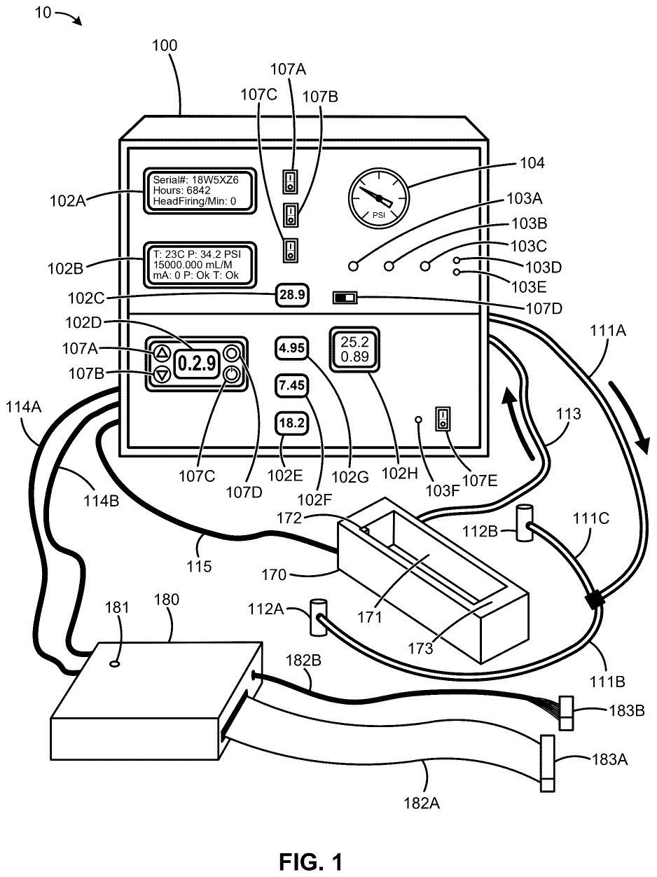

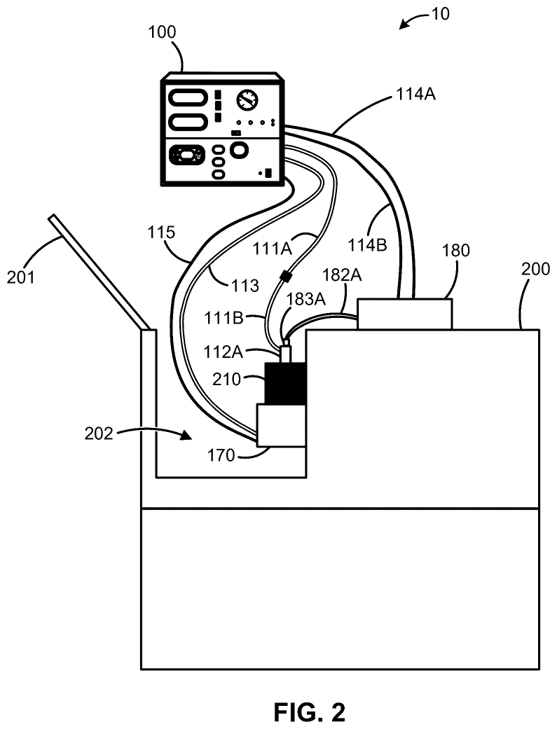

FIG. 1 is a perspective view of an example embodiment of a printhead-cleaning system, and FIG. 2 is a schematic illustration of the printhead-cleaning system when setup to clean a printhead. The printhead-cleaning system 10 can perform maintenance and diagnostic operations (e.g., electrical tests, cleaning operations) on printheads (e.g., the printhead 210 in FIG. 2) while the printheads are installed in printers.

The printhead-cleaning system 10 includes a console 100, a fluid collector 170, and a printhead-control device 180. While a printhead 210 is installed in a printer 200, the fluid collector 170 can be placed under the printhead 210 in the printhead compartment 202 that houses the printhead 210. The printhead compartment 202 can be accessed by opening a cover 201. Additionally, the fluid collector 170 may include one or more affixing mechanisms (e.g., dowel pins, clamps, claws, straps, bands, screws) that can hold the fluid collector 170 to the printhead 210. For example, the affixing mechanisms may hold the fluid collector 170 under, or both under and against, a baseplate or nozzle plate of the printhead 210.

The fluid collector 170 includes a fluid basin 171 that, when positioned under a nozzle area of the printhead 210, catches fluid (e.g., cleaning fluid) that is ejected by the nozzles of the printhead 210. The fluid basin 171 and the fluid collector 170 may be sized such that, when the fluid collector 170 is aligned to and held against the printhead 210, the fluid collector 170 does not contact the nozzle area of the printhead 210. For example, the length and width of the fluid basin 171 may be equal to or greater than the length and width of the nozzle area of the printhead 210. Accordingly, when the fluid collector 170 is aligned to and held against the printhead 210, the upper surface 173 of the fluid collector 170 would contact the nozzle plate (or base plate) of the printhead 210 only in a perimeter that surrounds the nozzle area.

The fluid collector 170 also includes a fluid-level sensor 172. The fluid-level sensor 172 detects the level of the cleaning fluid in the fluid basin 171 and sends one or more signals that indicate the detected fluid level to the console 100 via a collector-communication cable 115 (e.g., one or more wires).

When the printhead-cleaning system 10 is operating, a proximal fluid-supply conduit 111A conveys cleaning fluid from the console 100 to two other fluid-supply conduits 111B-C, which then convey the cleaning fluid to two printhead fluid connectors 112, which, when connected to the printhead 210, supply the cleaning fluid to the printhead 210. When the nozzles of the printhead 210 are being activated, the cleaning fluid travels through the printhead 210 and is ejected by the nozzles into the fluid basin 171 of the fluid collector 170. The cleaning fluid is conveyed back to the console 100 by a fluid-collection conduit 113 that is connected to the fluid collector 170 at one end and to the console 100 at the other end.

Therefore, while the printhead 210 is installed in the printer 200, the printhead-cleaning system 10 can supply cleaning fluid to the printhead 210 and recover the cleaning fluid that has traveled through the printhead 210.

Although FIG. 1 shows three fluid-supply conduits 111 and two printhead fluid connectors 112, some embodiments have different numbers of fluid-supply conduits 111 and printhead fluid connectors 112. For example, some embodiments include three printhead fluid connectors 112, each of which has a respective fluid-supply conduit 111. Also for example, some embodiments have only one fluid-supply conduit 111 and only one printhead fluid connector 112. These are only examples, and some embodiments have other configurations. And the number of fluid-supply conduits 111 and the number of printhead fluid connectors 112 can be changed according to the configuration of the printhead 210. Also, the fluid-supply conduits 111 may be insulated, which decreases the cooling of heated cleaning fluid as the heated cleaning fluid travels through the fluid-supply conduits 111 to the printhead 210.

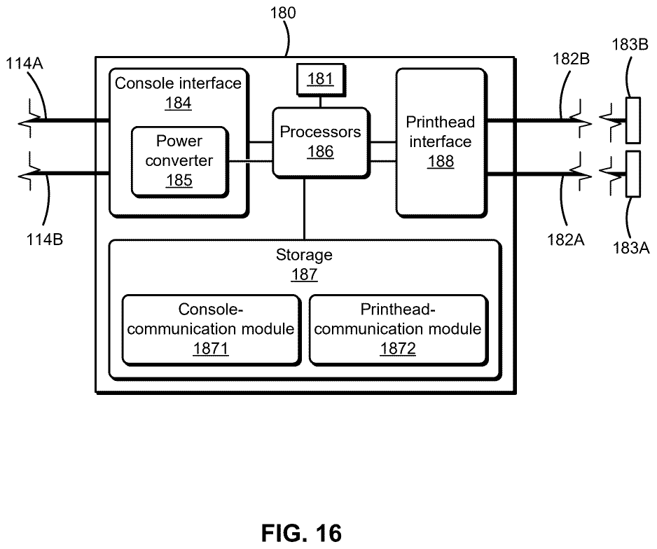

The console 100 communicates with, and supplies power to, the printhead-control device 180 via one or more controller-communication cables 114 (e.g., networking cables, fiber-optic cables, coaxial cables, ribbon cables, flexible flat cables). An example embodiment of a printhead-control device 180 is further described in FIG. 16.

The printhead-control device 180 communicates with, and supplies power to, the printhead 210 via one or more printhead-communication cables 182 and one or more electrical connectors 183 that are configured to connect to the electrical inputs of the printhead 210. Thus, while the printhead 210 is installed in the printer 200, the printhead-control device 180 communicates with the printhead 210 via the printhead-communication cables 182 (e.g., obtains information from the printhead), and the printhead-control device 180 controls the printhead 210 based on signals that the printhead-control device 180 receives from the console 100. For example, the printhead-control device 180 can control the nozzles of the printhead 210 to activate according to a firing pattern.

Because some printheads 210 are very sensitive to the signal quality on the printhead-communication cables 182, and because the signal quality on the printhead-communication cables 182 typically degrades as the length of the printhead-communication cables 182 increases, the printhead-communication cables 182 may be shorter than the one or more controller-communication cables 114. For example, in some embodiments, the printhead-communication cables 182 are less than 24 inches in length, less than 18 inches in length, less than 12 inches in length, or less than 6 inches in length.

In the example embodiment shown in FIG. 1, the printhead-control device 180 has two printhead-communication cables 182. And, in this embodiment, a first printhead-communication cable 182A is a ribbon cable or a flexible flat cable, and the first printhead-communication cable 182A has a respective electrical connector 183A. A second printhead-communication cable 182B is a bundle of wires, and the second printhead-communication cable 182B has a respective electrical connector 183B (the second printhead-communication cable 182B and the respective electrical connector 183B are not visible in FIG. 2).

The electrical connectors 183 are configured to communicate with (e.g., send signals to, receive signals from) and supply power to the printhead 210. Each electrical connector 183 may be able to connect to multiple electrical lines (e.g., voltage-supply lines, data-transmission lines), which may allow the printhead-control device 180 to communicate with the printhead 210 via multiple electrical lines in the printhead-communication cables 182. For example, in FIG. 1, the first printhead-communication cable 182A includes multiple electrical lines, and a first electrical connector 183A connects the electrical lines to the printhead 210. Accordingly, the electrical lines in the printhead-communication cables 182 may allow the printhead-control device 180 to activate one or more nozzles of the printhead 210, supply power to the printhead 210, obtain the temperature of the printhead 210 (e.g., by reading signals from one or more thermocouples in the printhead 210), or obtain other information from the printhead 210 (e.g., the model of the printhead, the serial number of the printhead 210, the total hours that the printhead 210 has operated).

Additionally, each of the electrical connectors 183 may be configured to connect with the wiring interface of one or more particular printhead models. For example, in FIG. 1, the first electrical connector 183A may be configured to connect to a ribbon-cable interface of the model of the printhead 210. Other electrical connectors (e.g., a second electrical connector 183B) may be configured to connect with the wiring interfaces of other models of printheads. Also, some printheads include multiple wiring interfaces and can simultaneously connect with multiple electrical connectors 183. For example, in some embodiments, the second electrical connector 183B supplies power to the printhead 210 and receives signals from a thermocouple in the printhead 210, and the first electrical connector 183A transmits control signals to the printhead 210.

Moreover, other embodiments may include more or fewer printhead-communication cables 182 and electrical connectors 183, different types of printhead-communication cables 182, or different types of electrical connectors 183. The number and types of the printhead-communication cables 182 and the electrical connectors 183 can be configured according to the printhead 210. Also, the printhead-control device 180 may be configured with various ports that are configured to connect with different printhead-communication cables 182, which allows a user to change the printhead-communication cables 182 that are connected to the printhead-control device 180 according to the model of the printhead 210. Furthermore, in some embodiments, different printhead-control devices 180 are configured to operate with different models of printheads, and the printhead-control device 180 that is attached to the console 100 can be selected according to the model of the printhead 210 that is to be connected to the printhead-control device 180.

The printhead-control device 180 also includes one or more status lights 180, which can be activated or deactivated to indicate different conditions of the printhead-control device 180 or the printhead 210. For example, a status light 180 may indicate the following: whether the printhead-control device 180 is receiving power, whether the printhead-control device 180 can communicate with the console 100, whether the printhead-control device 180 can communicate with the printhead 210, or whether the printhead-control device 180 has detected an anomaly (e.g., malfunction, an operating condition that is outside normal parameters) in the printhead 210.

Additionally, some embodiments of the printhead-cleaning system 10 omit the printhead-control device 180. In such embodiments, the printhead-communication cables 182 are connected to the console 100 instead of the printhead-control device 180, and the console 100 performs the functions of the printhead-control device 180.

Therefore, while the printhead 210 is installed in the printer 200, the printhead-cleaning system 10 can communicate with and control the printhead 210. For example, the printhead-cleaning system 10 can control to the printhead 210 to activate one or more nozzles (e.g., according to a firing pattern) and can obtain information from the printhead 210 (e.g., a temperature of the printhead 210).

The following description refers to embodiments that include the printhead-control device 180, and accordingly communication between the console 100 and the printhead 210 is, even when not explicitly stated, performed via the controller-communication cables 114, the printhead-control device 180, and the one or more printhead-communication cables 182. However, in embodiments that omit the printhead-control device 180, communication between the console 100 and the printhead 210 is performed via one or more printhead-communication cables 182 that directly connect the console 100 to the printhead 210.

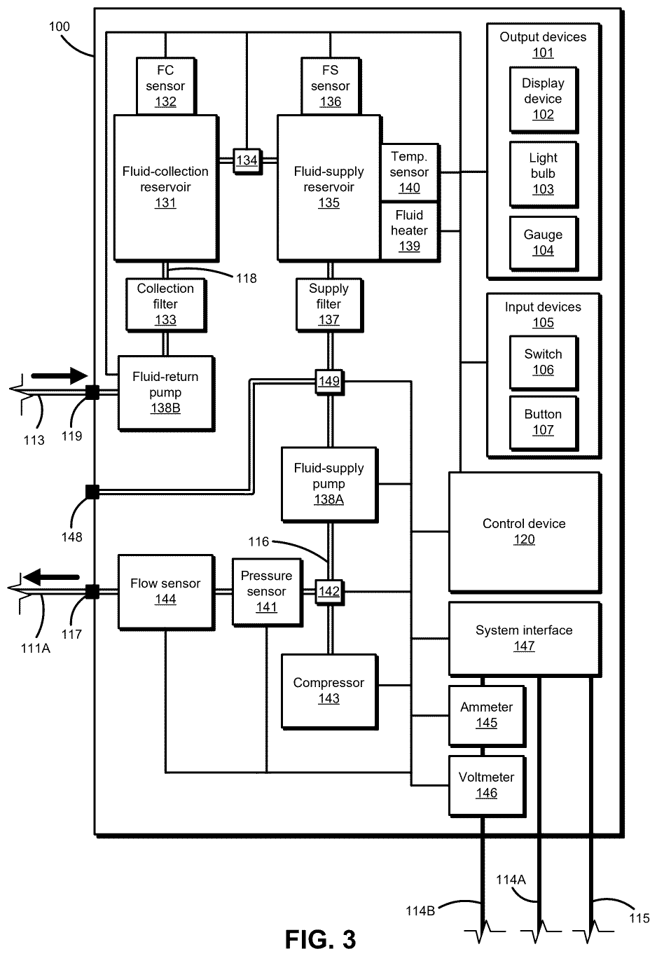

FIG. 1 includes a perspective view of an example embodiment of the console 100, and FIG. 3 is a schematic illustration of the example embodiment of the console 100. The console 100 includes a console-control device 120, one or more output devices 101, one or more input devices 105, a local fluid-supply conduit 116, a fluid-supply port 117, a local fluid-collection conduit 118, a fluid-collection port 119, a fluid-collection reservoir 131, a fluid-collection sensor 132, a collection filter 133, a transfer valve 134, a fluid-supply reservoir 135, a fluid-supply sensor 136, a supply filter 137, two fluid pumps 138 (a fluid-supply pump 138A and a fluid-return pump 138B), a fluid heater 139, at least one temperature sensor 140, a pressure sensor 141, a supply valve 142, an air compressor 143, a flow sensor 144, an ammeter 145, a voltmeter 146, a system interface 147, a fluid-input port 148, and a fluid-port valve 149.

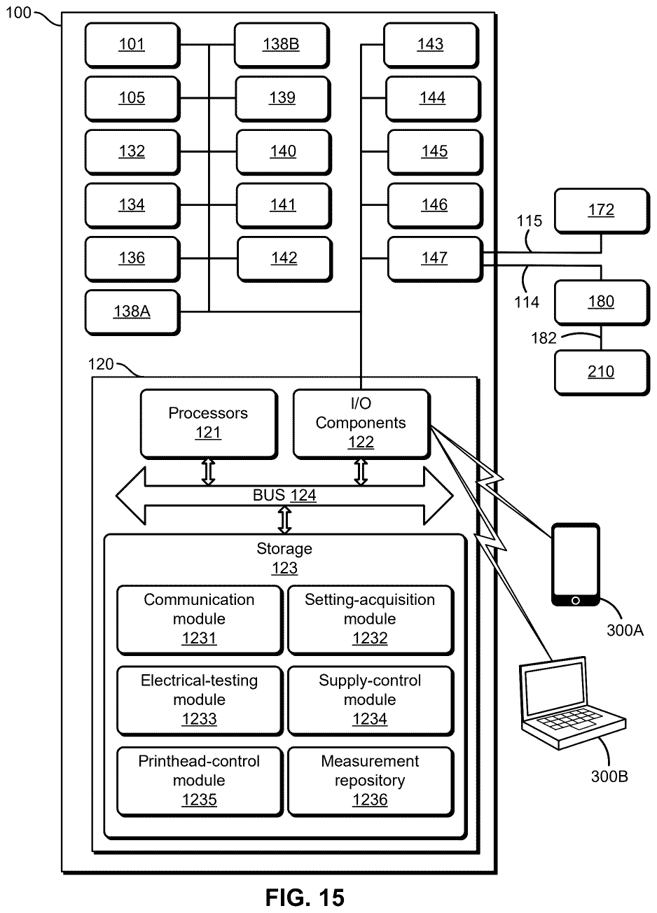

The console-control device 120 controls the operations of the console 100 and communicates with other devices (e.g., other computing devices). An example embodiment of a console-control device 120 is further described in FIG. 15.

In this embodiment, the output devices 101 include display devices 102, light bulbs 103, and a meter 104. Examples of display devices 102 include liquid-crystal displays (LCDs), touchscreens, LED displays, seven-segment displays, and nine-segment displays. In FIG. 3, the meter 104 is electrically connected to the pressure sensor 141. However, the meter 104 may be part of an analog gauge that is mechanically connected to the proximal fluid-supply conduit 111A. Some embodiments include other output devices 101 in addition to, or in alternative to, display devices 102, light bulbs 103, and meters 104. Other examples of output devices 101 include speakers and electrophoretic displays.

The display devices 102 display information about the maintenance process and the printhead 210. For example, the display devices 102 may display parameters of the maintenance process, such as cleaning-fluid temperature, cleaning-fluid pressure, time remaining in the process, cleaning-fluid levels, amperes supplied to the printhead, voltages supplied to the printhead, a nozzle-activation rate, a firing pattern, and a printhead temperature. And the display devices 102 may display information about the printhead 210, for example the model of the printhead 210 or the total hours that the printhead 210 has spent operating.

In this embodiment, the one or more input devices 105 include switches 106 and buttons 107. Some embodiments include other input devices 105 in addition to, or in alternative to, switches 106 and buttons 107. Other examples of input devices 105 include touchscreens, keypads, keyboards, and computer mice. A user can input various parameters via the input devices 105, for example the following: a temperature of the cleaning fluid, a pressure of the cleaning fluid, and a flow rate (e.g., a mass flow rate) through the fluid-supply conduit 111A.

The fluid-collection conduit 113 is connected to the local fluid-collection conduit 118 at the fluid-collection port 119. The fluid-return pump 138B moves cleaning fluid from the fluid collector 170 through the fluid-collection conduit 113, the fluid-collection port 119, and the local fluid-collection conduit 118 to the fluid-collection reservoir 131. While traveling from the fluid collector 170 to the fluid-collection reservoir 131, the cleaning fluid passes through the collection filter 133, which cleans the cleaning fluid before the cleaning fluid enters the fluid-collection reservoir 131. The fluid-collection (FC) sensor 132 detects the level of cleaning fluid in the fluid-collection reservoir 131.

The console 100 also includes a value 134, which the console 100 can open to transfer cleaning fluid from the fluid-collection reservoir 131 to the fluid-supply reservoir 135. The console 100 may include an additional filter that cleans the cleaning fluid as the cleaning fluid moves from the fluid-collection reservoir 131 to the fluid-supply reservoir 135.

The fluid-supply reservoir 135 stores cleaning fluid that can be supplied to the printhead 210. The fluid-supply (FS) sensor 136 detects the amount of cleaning fluid that is stored in the fluid-supply reservoir 135. The fluid heater 139 heats the cleaning fluid in the fluid-supply reservoir 135, which is the cleaning fluid that is supplied to the printhead 210. The at least one temperature sensor 140 detects the temperature of the cleaning fluid in the fluid-supply reservoir 135. The console-control device 120 can use the signals from the at least one temperature sensor 140 to control the temperature of the cleaning fluid in the fluid-supply reservoir 135. During a maintenance process, the console-control device 120 may control the fluid heater 139 to heat the cleaning fluid to a temperature that is higher than the normal operating temperature of the printhead 210. For example, if the normal operating temperature of the printhead 210 is 34° C., then some embodiments of the console-control device 120 control the fluid heater 139 to heat the cleaning fluid to a temperature between 35° C. and 40° C.

Additionally, some embodiments include two or more temperature sensors 140 that are configured to send warning signals to the console-control device 120 if a respective temperature threshold is exceeded. For example, one temperature sensor 140 may send a warning signal if the temperature exceeds 38° C., and another temperature sensor 140 may send a warning signal if the temperature exceeds 40° C. And the console-control device 120 may shut off the fluid heater 139 in response to receiving the warning signal that indicates that the temperature exceeds 40° C.

In FIG. 3, the fluid heater 139 and the at least one temperature sensor 140 are positioned inside or in contact with the fluid-supply reservoir 135. However, the fluid heater 139 and the at least one temperature sensor 140 may also be located elsewhere, such as adjacent to the local fluid-supply conduit 116 between the fluid-supply pump 138A and the pressure sensor 141, or adjacent to the local fluid-supply conduit 116 between the pressure sensor 141 and the flow sensor 144. Also, some embodiments include a temperature sensor on a surface of the fluid collector 170 that is closest to or that abuts the printhead 210, and some embodiments include a temperature sensor on a fluid-supply line 111 (e.g., near the printhead 210) or on a printhead fluid connector 112.

Furthermore, some embodiments include a plurality of fluid-supply reservoirs 135 and respective fluid-supply sensors 136, fluid heaters 139, and temperature sensors 140.

The local fluid-supply conduit 116 connects to the one or more fluid-supply conduits 111 at the fluid-supply port 117. And the fluid-supply pump 138A moves cleaning fluid from the fluid-supply reservoir 135 through the local fluid-supply conduit 116, the fluid-supply port 117, and one or more fluid-supply conduits 111 to the printhead 210. The cleaning fluid passes through a supply filter 137, which removes air (as well as other contaminants) from the cleaning fluid, thereby reducing or eliminating air bubbles.

The console 100 includes a valve 142 that enables the console 100 to switch from supplying cleaning fluid to suppling air (e.g., pressurized air) through the one or more fluid-supply conduits 111, which can be used to flush the one or more fluid-supply conduits 111. And the compressor 143 (or, in some embodiments, a fan or an air-supply port) supplies and pressurizes the air that is supplied to the one or more fluid-supply conduits 111.

The pressure sensor 141 detects the pressure of the cleaning fluid or any other fluid (e.g., ink, storage fluid) in the local fluid-supply conduit 116 (which may be close to or equal to the pressure in the proximal fluid-supply conduit 111A), and the flow sensor 144 detects the flow of the cleaning fluid or any other fluid through the local fluid-supply conduit 116 (which may be close to or equal to the flow in the proximal fluid-supply conduit 111A). Additionally, the console 100 may include a flushing valve that can be operated to flush the contents of the local fluid-supply conduit 116. Furthermore, based on the pressure that is detected by the pressure sensor 141, the console 100 can determine the pressure in the nozzles of the printhead 210.

The console 100 may also include at least one fluid-input port 148 and at least one fluid-port valve 149. The fluid-input port 148 is a port that can connect to an external fluid supply. For example, the fluid-input port 148 could be connected to an external supply of storage fluid (storage solution) or ink. And the fluid-port valve 149 can be operated to change the fluid that is supplied through the fluid-supply port 117 from the cleaning fluid in the fluid-supply reservoir 135 to the fluid (e.g., storage fluid, ink) that is supplied through the fluid-input port 148 and vice versa.

Furthermore, the console 100 includes a system interface 147, though which the console 100 communicates with the printhead-control device 180 (and, via the printhead-control device 180, with the printhead 210) via the one or more controller-communication cables 114 and communicates with the fluid-level sensor 172 via the collector-communication cable 115.

The console 100 can supply power to the printhead-control device 180 and the printhead 110 via the one or more controller-communication cables 114. And the console 100 includes an ammeter 145 and a voltmeter 146 that can detect the voltage and the current that are supplied to the printhead 210 via one or more wires of at least one of the one or more controller-communication cables 114. The voltage and current that are supplied to the printhead 210 via the one or more controller-communication cables 114 during a maintenance process can indicate the status and the condition of the printhead 210. For example, the current indicates whether the nozzles of the printhead 210 are being activated, and the current can also indicate the amount of wear of the printhead 210. Also for example, the console-control device 120 can use the current and voltage that are supplied to the printhead 210 to generate a nozzle map, which may indicate how the printhead 210 has been used in the past and which piezo-electric actuators were the most active. And the console-control device 120 can use the current and voltage that are supplied to the printhead 210 (e.g., as indicated in a nozzle map) to determine parameters of a cleaning process. Examples of such parameters include the following: the type of cleaning action, the voltage, and the durations of various portions of the cleaning process. Also, because the current that is used to power the printhead-control device 180 is known, that current can be accounted for in the current that is detected by the ammeter 145 when determining the current that is supplied to the printhead 210.

Therefore, the printhead-cleaning system 10 can perform maintenance and diagnostic operations (e.g., electrical tests, cleaning operations) on the printhead 210 while the printhead 210 is installed in the printer 200. For example, while the printhead 210 is installed in the printer 200, the printhead-cleaning system 10 can supply cleaning fluid to the printhead 210, recover cleaning fluid that has traveled through the printhead 210, activate one or more nozzles of the printhead 210, measure and record the current and voltage that are supplied to the printhead 210, measure and record the fluid pressure in the nozzles (e.g., as the nozzles are activated), and measure and record the temperature of the printhead 210.

Performing maintenance and diagnostic operations while the printhead 210 is installed in the printer 200 has several advantages, such as the following: (1) eliminating the expenditure of labor required to remove the printhead 210 from the printer 200, which may be several hours of labor; (2) eliminating the expenditure of labor required to reinstall the printhead 210 in the printer 200 (which may include alignments on multiple axes, optical density adjustment, and other calibration operations), which may be several hours of labor; (3) eliminating the risk of damage to the printhead 210 that accompanies the removal and reinstallation of the printhead 210; (4) eliminating the risk of damage to the printhead 210 that accompanies packing and shipping the printhead 210 to a remote location for servicing; and (5) reducing the time during which the printer 200 is inoperable.

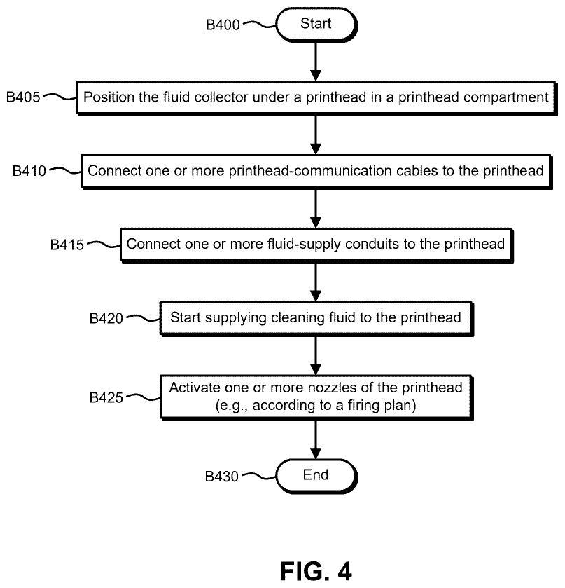

FIG. 4 illustrates an example embodiment of an operational flow for performing maintenance on a printhead. Although this operational flow and the other operational flows that are described herein are each presented in a certain order, some embodiments may perform at least some of the operations in different orders than the presented orders. Examples of different orders include concurrent, parallel, overlapping, reordered, simultaneous, incremental, and interleaved orders. Thus, other embodiments of the operational flows that are described herein may omit blocks, add blocks, change the order of the blocks, combine blocks, or divide blocks into more blocks.

The flow starts in block B400 and moves to block B405, where a user (e.g., field technician) positions a fluid collector 170 under a printhead 210 in a printhead compartment 202 of a printer 200 while the printhead 210 is installed in the printer 200. Next, in block B410, the user connects one or more printhead-communication cables 182 to the printhead 210. Then, in block B415, the user connects one or more fluid-supply conduits 111 to the printhead 210.

The flow then proceeds to block B420, where the console 100 starts supplying cleaning fluid to the printhead 210 via one or more fluid-supply conduits 111. In block B420, the console 100 activates the fluid pump 138 and adjusts the supply valve 142 and the fluid-port valve 149 to allow cleaning fluid to flow from the fluid-supply reservoir 135 to the fluid-supply conduits 111. And the console 100 may start the supply of cleaning fluid in response to an instruction that the user inputs via an input device 105.

The flow then moves to block B425, where the console 100 sends signals to the printhead-control device 180, via the controller-communication cables 114, that cause the printhead-control device 180 to send one or more electrical signals to the printhead 210, via the one or more printhead-communication cables 182, that activate one or more nozzles of the printhead 210. Because the one or more nozzles are being activated while cleaning fluid is being supplied to the printhead 210, the nozzles, when activated, eject cleaning fluid. For example, the printhead-control device 180 may activate one or more piezo-electric actuators of the printhead, thereby causing cleaning fluid to be ejected from the respective nozzles of the piezo-electric actuators.

The printhead-control device 180 may activate the nozzles according to a firing plan. For example, the nozzles may be activated according to a firing sequence; the nozzles in areas of the printhead may be activated together, progressing though each area in series; or all non-adjacent nozzles may be activated simultaneously (e.g., alternating between even-and odd-numbered nozzles). The printhead-control device 180 may activate the nozzles to make the nozzles work harder during cleaning than during printing, which increases the output pressure at the nozzles. For example, the printhead-control device 180 may increase the duty cycle per pulse of the printhead 210 and increase the firing rate of the printhead 210. Also, the printhead-control device 180 may not activate all of the nozzles simultaneously. For example, the printhead-control device 180 may alternate between two or more nozzle groups while activating the nozzles. And the console 100 may start activating the nozzles in response to an instruction that the user inputs via an input device 105.

Finally, the flow ends in block B430.

Additionally, in blocks B405-B425, the console 100 may indicate the status of the maintenance operations on one or more output devices 101 (e.g., display devices 102, light bulbs 103, meters 104).

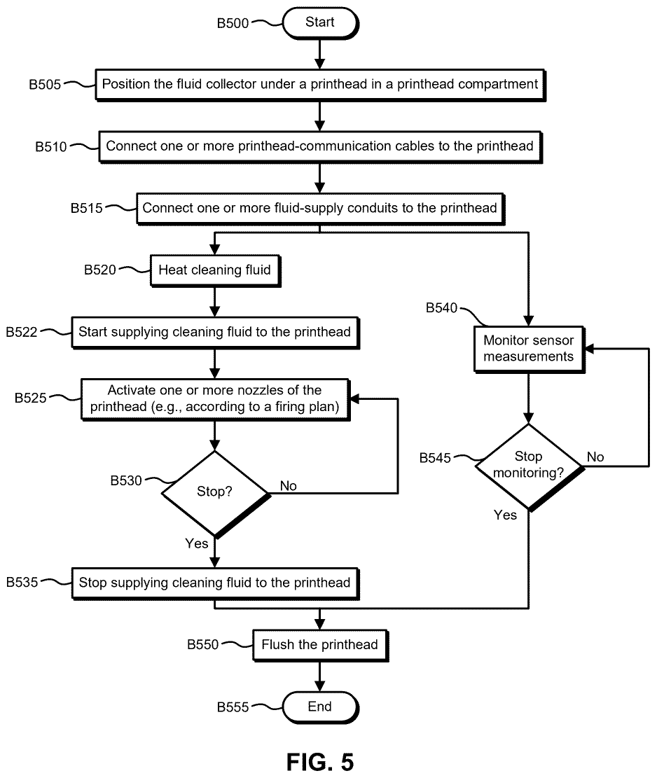

FIG. 5 illustrates an example embodiment of an operational flow for performing maintenance on a printhead. The flow starts in block B500 and moves to block B505, where a user (e.g., field technician) positions a fluid collector 170 under a printhead 210 that is installed in a printhead compartment 202 of a printer 200. Next, in block B510, the user connects one or more printhead-communication cables 182 to the printhead 210. Then, in block B515, the user connects one or more fluid-supply conduits 111 to the printhead 210.

The flow then splits into a first flow and a second flow, which are performed concurrently. The first flow proceeds to block B520, and the second flow moves to block B540.

In block B520, the console 100 controls the fluid heater 139 to heat the cleaning fluid. For example, the console 100 may control the fluid heater 139 to heat cleaning fluid that is stored in the fluid-supply reservoir 135. Then, in block B522, the console 100 starts supplying cleaning fluid to the printhead 210 via one or more fluid-supply conduits 111 (e.g., as described in block B420 in FIG. 4).

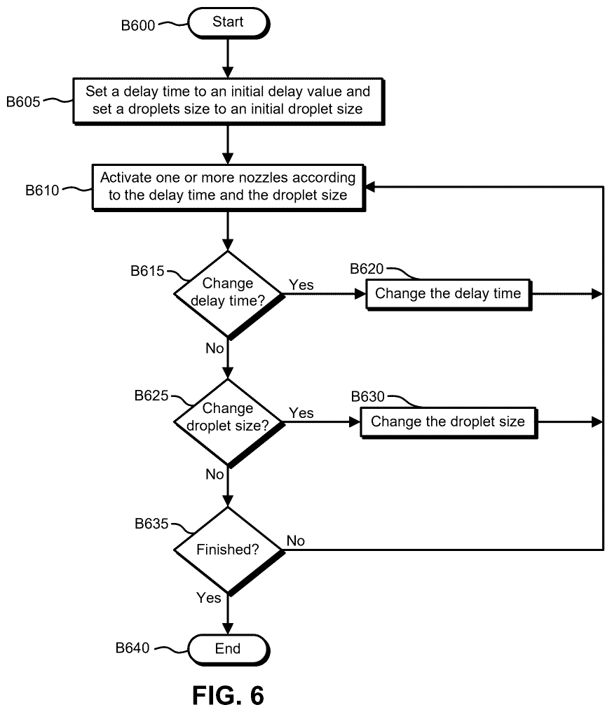

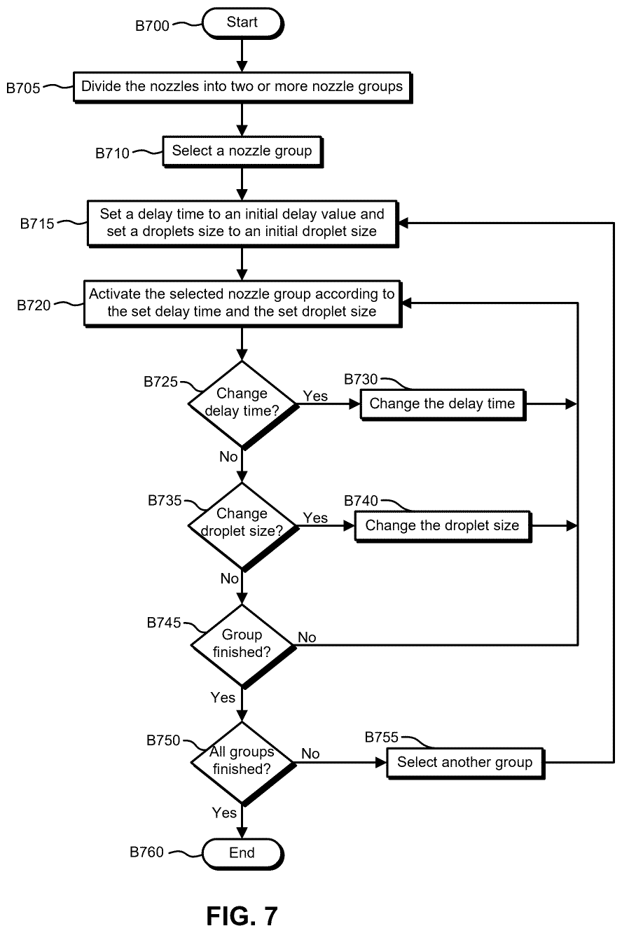

The first flow then moves to block B525, where the console 100 sends signals to the printhead-control device 180, via the controller-communication cables 114, that cause the printhead-control device 180 to send one or more electrical signals to the printhead 210, via the one or more printhead-communication cables 182, that activate one or more nozzles of the printhead 210. Because the one or more nozzles are being activated while cleaning fluid is being supplied to the printhead 210, the nozzles, when activated, eject cleaning fluid. For example, the console 100 may activate one or more piezo-electric actuators or heater elements of the printhead, thereby causing cleaning fluid to be ejected from the respective nozzles of the piezo-electric actuators or heater elements. The nozzles may also be activated according to a firing plan (e.g., as described in FIG. 6 or in FIG. 7).

The flow then moves to block B530, where the console 100 determines whether to stop supplying cleaning fluid to the printhead 210 and whether to stop activating the nozzles of the printhead 210 based on one or more conditions. Examples of conditions include the following: whether cleaning fluid has been supplied for more than a predetermined time, whether a threshold amount of cleaning fluid has been supplied to the printhead, whether a number of times that the one or more nozzles have been activated exceeds a threshold, whether a firing plan has been finished, and whether an error has been detected. Examples of errors include fluid leakage, an empty cleaning-fluid-supply tank, a supplied current that exceeds a threshold, a full cleaning-fluid-collection reservoir, and insufficient fluid pressure. If the console 100 determines not to stop supplying cleaning fluid to the printhead 210 (B530=No), then the first flow returns to block B525. If the console 100 determines to stop supplying cleaning fluid to the printhead 210 (B530=Yes), then the first flow proceeds to block B535.

In block B535, the console 100 stops supplying cleaning fluid to the printhead 210, which includes stopping the fluid pump 138. Also, because the flow does not return to block B525, the console 100 stops activating the nozzles of the printhead 210. The first flow then advances to block B550, where the first flow rejoins the second flow.

From block B515, the second flow proceeds to block B540. In block B540, the console 100 monitors sensor measurements from one or more of the sensors (e.g., the fluid-collection sensor 132, the fluid-supply sensor 136, the temperature sensor 140, the pressure sensor 141, the flow sensor 144, the ammeter 145, the voltmeter 146, the fluid-level sensor 172) in the printhead-cleaning system 10. And the console 100 monitors the temperature of the printhead 210 via signals that are received from the printhead 210 (e.g., a thermocouple in the printhead 210). For example, when the one or more nozzles of the printhead are activated in block B525 (which is performed concurrently with block B540), the console 100 may monitor sensor measurements from the ammeter 145, which detects the amperes that flow to the printhead 210, monitor measurements from the voltmeter 146, which detects the voltage that is supplied to the printhead 210, and monitor signals from a thermocouple in the printhead 210, which indicate a temperature of the printhead 210.

Then, in block B545, the console 100 determines whether to stop monitoring the sensor measurements based on one or more conditions. Examples of conditions include the following: whether cleaning fluid has been supplied for more than a predetermined time, whether a threshold amount of cleaning fluid has been supplied to the printhead, whether a number of times that the one or more nozzles have been activated exceeds a threshold, whether a firing plan has been finished, whether the supply of cleaning fluid has been stopped (e.g., in block B535), and whether an error has been detected. If the console 100 determines not to stop monitoring the sensor measurements (B545=No), then the second flow returns to block B540. If the console 100 determines to stop monitoring the sensor measurements (B545=Yes), then the second flow proceeds to block B550, where the second flow rejoins the first flow.

In block B550, the console 100 supplies ink or storage solution to the printhead 210 via the fluid-input port 148 and the fluid-port valve 149, which flushes the cleaning fluid from the printhead 210. The flow then ends in block B555. And, in some embodiments, the console 100 sends data about the maintenance process (e.g., log data) to another device.

Additionally, in blocks B520-B550, the console 100 may indicate the status of the maintenance operations on one or more output devices 101 (e.g., display devices 102, light bulbs 103, meters 104).

FIG. 6 illustrates an example embodiment of an operational flow for activating nozzles according to a firing plan, which may include different combinations of delay times and droplet sizes. The flow starts in block B600 and moves to block B605, where a console 100 sets a delay time to an initial delay value and sets a droplet size to an initial droplet size. A delay time is the interval of time between nozzle activations, and thus decreasing the delay time is equivalent to increasing the activation rate. In contrast, a nozzle-activation frequency indicates the length of time from the beginning of an activation pulse to the end of an activation pulse of a nozzle. The delay time and the droplet size may be entered by a user or determined by the console-control device 120 (e.g., based on the model of the printhead 210). For example, based on the model of the printhead 210, the console-control device 120 may obtain the droplet size from a storage in which the model and droplet size are stored in association with each other.

The flow then moves to block B610, where the console 100 activates one or more nozzles of the printhead 210 by sending one or more electrical signals to the printhead 210 via one or more printhead-communication cables 182. The nozzles are activated according to the set delay time and the set droplet size. Thus, after the initial nozzle activation, the console 100 waits until the delay time has elapsed before activating the nozzles again. When the one or more nozzles are being activated while cleaning fluid is being supplied to the printhead 210, the nozzles, when activated, eject droplets of cleaning fluid. And the nozzles eject the droplets according to the set droplet size.

Also, the delay time may be less than the delay time during normal operation of the printhead, and thus the nozzle-activation rate of a nozzle of the printhead 210 may be higher a nozzle-activation rate of the nozzle during normal operation of the printhead 210. Also, a nozzle-activation voltage or current may be a higher or lower than the nozzle-activation voltage or current during normal operation of the printhead 210.

The flow then proceeds to block B615, where the console 100 determines, based on the firing plan, whether to change the delay time. For example, the firing plan may indicate that a certain number of activations are performed while a certain delay time is set before changing the delay time, or the firing plan may indicate that nozzle activations are performed for a duration of time while a certain delay time is set before changing the delay time. And the firing plan may include a sequence of delay times that the console 100 progresses through. For example, some sequences of delay times include two delay times, three delay times, four or more delay times, ten delay times, ten to twenty delay times, or more than twenty delay times. If the console 100 determines to change the delay time (B615=Yes), then the flow advances to block B620, where the console 100 changes the delay time (e.g., increases the delay time, reduces the delay time) according to the firing plan. And the flow then returns to block B610. If the console 100 determines not to change the delay time (B615=No), then the flow proceeds to block B625.

In block B625, the console 100 determines, based on the firing plan, whether to change the droplet size. For example, the firing plan may indicate that the droplet size should be changed after a particular number of nozzle activations or after a particular duration of time. And the firing plan may include a sequence of droplet sizes that the console 100 progresses through. For example, some sequences of delay times include two droplet sizes or three droplet sizes, and some sequences include as many droplet sizes as the printhead is capable of producing. If the console 100 determines to change the droplet size (B625=Yes), then the flow moves to block B630, where the console 100 changes the droplet size (e.g., increases the droplet size, reduces the droplet size) according to the firing plan. And the flow then returns to block B610. If the console 100 determines not to change the droplet size (B625=No), then the flow advances to block B635.

In block B635, the console 100 determines whether the firing plan is finished. If the console 100 determines that the firing plan is not finished (B635=No), then the flow returns to block B610. If the console 100 determines that the firing plan is finished (B635=Yes), then the flow ends in block B640.

FIG. 7 illustrates an example embodiment of an operational flow for activating nozzles according to a firing plan.

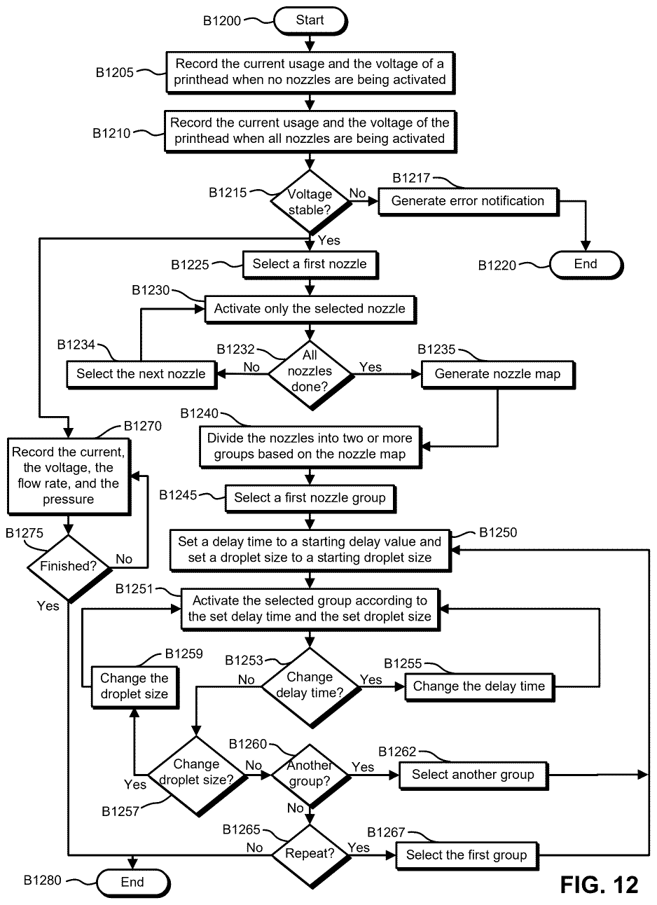

The flow starts in block B700 and moves to block B705, where a console 100 divides the nozzles of a printhead into two or more nozzle groups (which are groups of nozzles), for example as described in blocks B1225-B1240 in FIG. 12. Each nozzle may be assigned to only one nozzle group, and there may be no nozzles that are not assigned to a nozzle group.

Next, in block B710, the console selects a nozzle group from the two or more nozzle groups. Then, in block B715, the console 100 sets a delay time to an initial delay value and sets a droplet size to an initial droplet size. The flow then moves to block B720, where the console 100 activates the selected nozzle group according to the set delay time and the set droplet size.

The flow then proceeds to block B725, where the console 100 determines, based on the firing plan, whether to change the delay time. If the console 100 determines to change the delay time (B725=Yes), then the flow advances to block B730, where the console 100 changes the delay time (e.g., increases the delay time, reduces the delay time) according to the firing plan. And the flow then returns to block B720. If the console 100 determines not to change the delay time (B725=No), then the flow proceeds to block B735.

In block B735, the console 100 determines, based on the firing plan, whether to change the droplet size. If the console 100 determines to change the droplet size (B735=Yes), then the flow moves to block B740, where the console 100 changes the droplet size (e.g., increases the droplet size, reduces the droplet size) according to the firing plan. And the flow then returns to block B720. If the console 100 determines not to change the droplet size (B735=No), then the flow advances to block B745.

In block B745, the console 100 determines whether the firing plan is finished for the selected nozzle group. If the console 100 determines that the firing plan is not finished (B745=No), then the flow returns to block B720. If the console 100 determines that the firing plan is finished (B745=Yes), then the flow proceeds to block B750.

In block B750, the console 100 determines whether all of the nozzle groups are finished. If the console 100 determines that all of the nozzle groups are not finished (B750=No), then the flow proceeds to block B755, where the console selects another nozzle group. The flow then returns to block B715. If the console 100 determines that all of the nozzle groups are finished (B750=Yes), then the flow ends in block B760.

Additionally, some embodiments of the console 100 repeat FIG. 7 multiple times during a maintenance procedure.

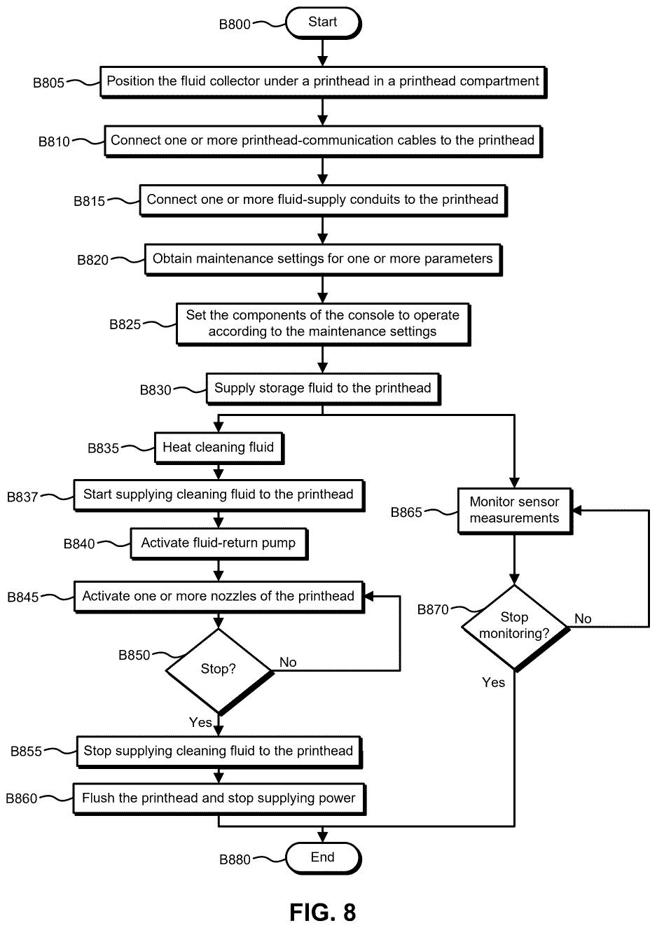

FIG. 8 illustrates an example embodiment of an operational flow for performing maintenance and diagnostics on a printhead. The flow starts in block B800 and moves to block B805, where a user positions a fluid collector 170 under a printhead 210 in a printhead compartment 202 of a printer 200. Next, in block B810, the user connects one or more printhead-communication cables 182 to the printhead 210. Then, in block B815, the user connects one or more fluid-supply conduits 111 to the printhead 210.

The flow then proceeds to block B820, where the console 100 obtains maintenance settings for one or more parameters. For example, the maintenance settings may include settings for one or more of the following parameters: cleaning duration, duration in which cleaning-fluid is supplied, duration of pressurized fluid purge, cleaning-fluid pressure, cleaning-fluid temperature, nozzle-activation rate, nozzle-activation current, nozzle-activation voltage, nozzle-activation waveform, nozzle-activation duration, and one or more test voltages. And at least some of the maintenance settings may be included in a firing plan. The console 100 may obtain maintenance settings from user entry via the input devices 105, from internal storage, or from another computing device (for example via a network). Also, some embodiments of the console 100 automatically detect the model of the printhead 210 and retrieve the maintenance settings for the detected model from internal storage or from an external device (e.g., an external storage device, an external computing device).

Then, in block B825, the console 100 sets its applicable components (e.g., a transfer valve 134, a fluid-supply pump 138A, a fluid-return pump 138B, a fluid heater 139, a supply valve 142) to operate according to the maintenance settings. Next, in block B830, the console 100 supplies storage fluid to the printhead 210 via the fluid-input port 148, the fluid-port valve 149, and the one or more fluid-supply conduits 111. The supplied storage fluid may flush ink and other materials out of the printhead 210. The flow then splits into a first flow and a second flow, which are performed concurrently. The first flow proceeds to block B835, and the second flow moves to block B865.

In block B835, the console 100 controls the fluid heater 139 to heat the cleaning fluid. Next, in block B837, the console 100 starts supplying cleaning fluid to the printhead 210 via one or more fluid-supply conduits 111 (e.g., as described in block B420 in FIG. 4). And in block B840, the console 100 activates the fluid-return pump 138B.

The first flow then moves to block B845, where the console 100 activates one or more nozzles of the printhead 210 by sending one or more electrical signals to the printhead 210 via one or more printhead-communication cables 182 (e.g., as described in block B525 in FIG. 5). And block B840 can be performed simultaneously with or after the first execution of block B845.

The flow then moves to block B850, where the console 100 determines whether to stop supplying cleaning fluid to the printhead 210 and stop activating the nozzles of the printhead 210 (e.g., as described in block B530 in FIG. 5). If the console 100 determines not to stop (B850=No), then the first flow returns to block B845.

Also, during the iterations of blocks B845 and B850, the console 100 may activate the nozzles of the printhead according to a firing plan (e.g., as described in FIG. 6 or in FIG. 7).

If the console 100 determines to stop (B850=Yes), then the first flow proceeds to block B855.

In block B855, the console 100 stops supplying cleaning fluid to the printhead 210. Also, because the flow does not return to block B845, the console 100 stops activating the nozzles of the printhead 210. Next, in block B860, the console 100 supplies ink or storage fluid to the printhead 210 via the fluid-input port 148, which flushes the cleaning fluid from the printhead 210, and the console 100 then stops supplying power to the printhead 210. The first flow then ends in block B880.

From block B830, the second flow proceeds to block B865. In block B865, the console 100 monitors sensor measurements from one or more sensors in the printhead-cleaning system 10 and in the printhead. Examples of sensors include the following: the fluid-collection sensor 132, the fluid-supply sensor 136, the temperature sensor 140, the pressure sensor 141, the flow sensor 144, the ammeter 145, the voltmeter 146, the fluid-level sensor 172 in the fluid collector 170, and a thermocouple in the printhead 210. Also, examples of the sensor measurements include the following: the respective amperes flowing through one or more electrical lines (e.g., a piezo-actuator current, a heater-element current), which may include the nozzle-activation current; the respective voltages one of or more electrical lines, which may include the nozzle-activation voltage; cleaning-fluid temperature; cleaning-fluid pressure; the flow rate of the cleaning fluid that is supplied to the nozzles; the pressure of the cleaning fluid that is supplied to the nozzles; and printhead temperature. The console 100 may record the measurements over a period of time. And the console 100 records the sensors measurements in a log.

Then, in block B870, the console 100 determines whether to stop monitoring the sensor measurements (e.g., as described in block B545 in FIG. 5). If the console 100 determines not to stop monitoring the sensor measurements (B870=No), then the second flow returns to block B865. If the console 100 determines to stop monitoring the sensor measurements, then the second flow ends in block B880. And, in some embodiments, the console 100 sends data about the maintenance process (e.g., recorded sensor measurements, such as a log of the measurements) to another device.

Additionally, in blocks B820-B870, the console 100 may indicate the maintenance settings or the status of the maintenance operations on one or more output devices 101 (e.g., display devices 102, light bulbs 103, meters 104).

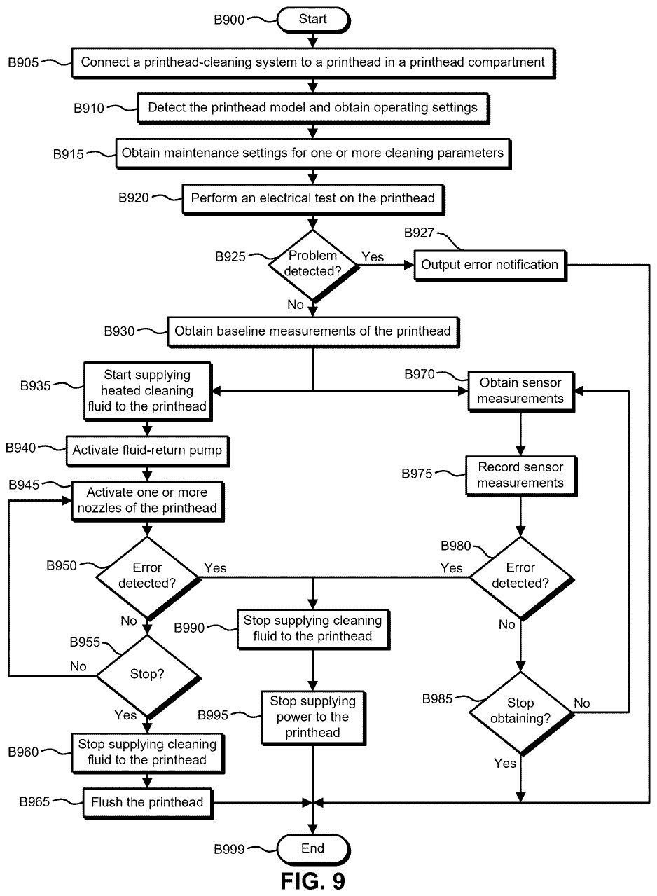

FIG. 9 illustrates an example embodiment of an operational flow for performing maintenance and diagnostics on a printhead. The flow starts in block B900 and moves to block B905, where a user connects a printhead-cleaning system 10 to a printhead 210 while the printhead 210 is installed in a printhead compartment 202 of a printer 200. Block B905 includes connecting one or more fluid-supply conduits 111 to the printhead 210, positioning a fluid collector 170 under the printhead 210, and connecting one or more printhead-communication cables 182 to the printhead 210.

Next, in block B910, the console 100 detects the model of the printhead 210 via the controller-communication cables 114, the printhead-control device 180, and the one or more printhead-communication cables 182. The console 100 then obtains operating settings for the detected model of the printhead 210, for example from internal storage or from another computing device. The operating settings include the respective settings of one or more parameters that are used during normal operation of the printhead 210. Examples of operating settings include the settings for the following parameters: voltage range (a range includes both high and low thresholds), maximum voltage, minimum voltage, current range, maximum current, minimum current, fluid-pressure range, fluid-pressure maximum, fluid-pressure minimum, fluid-temperature range, fluid-temperature maximum, fluid-temperature minimum, printhead-temperature range, printhead-temperature maximum, printhead-temperature minimum, maximum nozzle-activation rate, maximum nozzle-activation voltage, and a nozzle-activation waveform.

The flow then proceeds to block B915, where the console 100 obtains maintenance settings for one or more cleaning parameters, for example as described in block B820 in FIG. 8.

Furthermore, the maintenance settings may be outside of the normal operating settings of the printhead 210. For example, in some embodiments, the output current of one or more power-supply lines are higher or lower than the current of the power-supply lines in the operating settings, the fluid pressure of the cleaning fluid is higher or lower than a fluid pressure of the printhead in the operating settings, the fluid temperature of the cleaning fluid is higher or lower than a temperature of the printhead in the operating settings, the temperature of the printhead is higher or lower than a temperature of the printhead in the operating settings, a nozzle-activation delay (the length of time between activations) of a nozzle of the printhead is higher or lower than a nozzle-activation delay of the nozzle in the operating settings, a nozzle-activation frequency (the length of time from the beginning of an activation pulse to the end of an activation pulse) of a nozzle of the printhead is higher or lower than a nozzle-activation frequency of the nozzle in the operating settings, or a nozzle-activation current is a higher or lower than the nozzle-activation current in the operating settings.

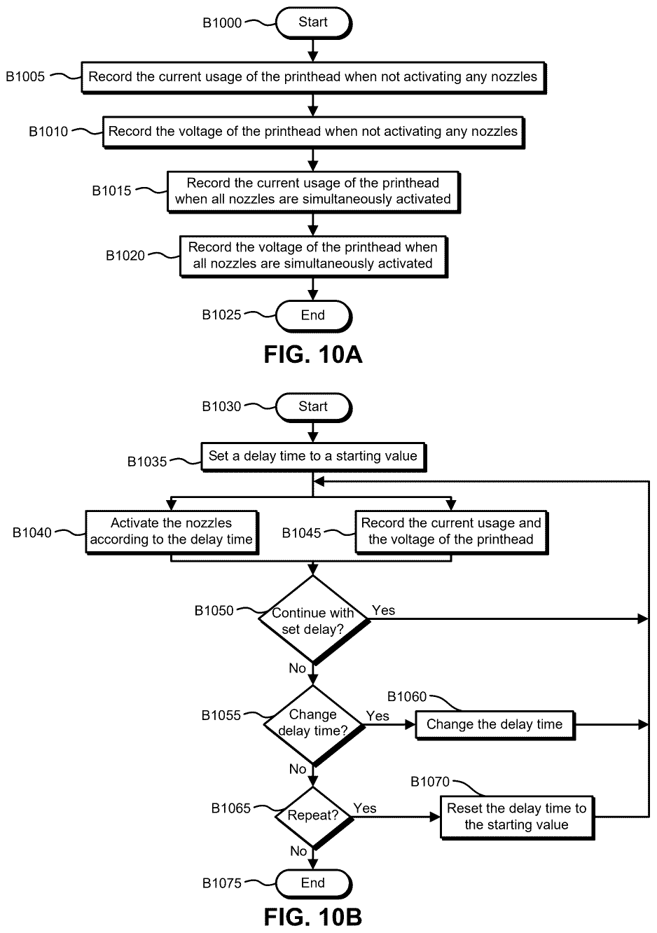

The flow then moves to block B920, where the console 100 performs an electrical test on the printhead 210, for example as described in FIG. 10A.

The flow then moves to block B925, where the console 100 determines whether a problem was detected during the electrical test. For example, a problem may be detected if the current that was detected on an electrical line while a voltage was being applied exceeded a current threshold that was included in the operating settings that were obtained in block B910. Also, a problem may be detected if the voltage of the printhead during the electrical test was not sufficiently stable. For example, if the electrical test in FIG. 10A is performed, the voltage may be sufficiently stable if the voltage of the printhead when all of the nozzles were being activated is within 1 mV (+/−1 mV) of the voltage of the printhead when none of the nozzles were being activated.

If the console 100 determines that a problem was detected (B925=Yes), then the flow advances to block B927, where the console 100 outputs an error notification, and then the flow ends in block B999. If the console 100 determines that a problem was not detected (B925=No), then the flow moves to block B930.

In block B930, the console obtains baseline measurements of the printhead, for example as described in FIG. 10B. After block B930, the flow splits into a first flow and a second flow, which the console 100 performs concurrently.

The first flow proceeds to block B935, where the console 100 starts supplying heated cleaning fluid to the printhead via the one or more fluid-supply conduits 111 (e.g., as described in block B420 in FIG. 4) according to the maintenance settings (e.g., temperature settings, pressure settings). For example, the console 100 may control the fluid heater 139 to heat cleaning fluid in the fluid-supply reservoir 135 according to the maintenance settings.

Next, in block B940, the console 100 activates the fluid-return pump 138B. The first flow then moves to block B945, where the console 100 activates one or more nozzles of the printhead 210, according to the maintenance settings, by sending one or more electrical signals to the printhead 210 via one or more printhead-communication cables 182 (e.g., as described in block B525 in FIG. 5). And block B940 can be performed simultaneously with or after the first execution of block B945.

The first flow then proceeds to block B950, where the console 100 determines whether an error has been detected (as described below in block B980). An error is an anomaly of such magnitude that the operational flow should be aborted to avoid damage to the printhead 210, for example overheating or an electrical short. If the console 100 determines that an error has been detected (B950=Yes), then the first flow moves to block B990, where the first flow rejoins the second flow. If the console 100 determines that an error has not been detected (B950=No), then the first flow moves to block B955.

In block B955, the console 100 determines whether to stop supplying cleaning fluid to the printhead 210 and stop activating the nozzles (e.g., as described in block B530 in FIG. 5). If the console 100 determines not to stop (B955=No), then the first flow returns to block B945. During the iterations of blocks B945-B955, the console 100 may activate the nozzles of the printhead according to a firing plan (e.g., as described in FIG. 6 or in FIG. 7).

If the console 100 determines to stop (B955=Yes), then the first flow proceeds to block B960. In block B960, the console 100 stops supplying cleaning fluid to the printhead 210. Also, because the flow does not return to block B945, the console 100 stops activating the nozzles of the printhead 210. Next, in block B965, the console 100 supplies ink or storage fluid to the printhead 210 via the fluid-input port 148, which flushes the cleaning fluid from the printhead 210. The first flow then ends in block B999.

From block B930, the second flow proceeds to block B970. In block B970, the console 100 obtains measurements from one or more sensors, for example as described in block B865 in FIG. 8.

In block B975, the console 100 records the obtained sensor measurements and other maintenance information in non-volatile storage (e.g., a flash-memory device). Examples of other maintenance information include the following: nozzle-activation voltage, nozzle-activation waveform, and total time of nozzle-activation. For example, the console 100 may record the obtained sensor measurements in a log in non-volatile storage. Also, the console 100 may output the obtained sensor measurements and other maintenance information to another device, for example via wireless communication. And console 100 may output the obtained sensor measurements and other maintenance information as they are obtained (e.g., in real time or near real time).

The flow then proceeds to block B980, where the console 100 determines whether an error has been detected based on the sensor measurements and, in some embodiments, on the maintenance settings or on the operating settings. For example, the console may determine that an error has been detected when a detected temperature (such as the temperature of the printhead 210) exceeds a threshold, when a fluid pressure that is detected by the pressure sensor 141 exceeds a threshold, when a fluid pressure that is detected by the pressure sensor 141 falls below a threshold, when a fluid level that is detected by the fluid-collection sensor 132 or the fluid-level sensor 172 exceeds a threshold, when a fluid level that is detected by the fluid-supply sensor 136 falls below a threshold, when a voltage that is detected by the voltmeter 146 exceeds a threshold, when an electrical current that is detected by the ammeter 145 exceeds a threshold, when a fluid flow that is detected by the flow sensor 144 exceeds a threshold, or when a fluid flow that is detected by the flow sensor 144 falls below a threshold. These are examples, and some embodiments of the console 100 detect errors when other conditions are satisfied.

If the console 100 determines that an error has been detected (B980=Yes), then the second flow moves to block B990, where the second flow rejoins the first flow. If the console 100 determines that an error has not been detected (B980=No), then the second flow proceeds to block B985.

In block B985, the console 100 determines whether to stop obtaining sensor measurements (e.g., as described in block B545 in FIG. 5). If the console 100 determines not to stop obtaining sensor measurements (B985=No), then the second flow returns to block B970. If the console 100 determines to stop obtaining sensor measurements (B985=Yes), then the second flow ends in block B999.

In block B990, the console 100 stops supplying cleaning fluid to the printhead 210. Then, in block B995, the console 100 stops the supply of power to the printhead 210. And then the flow ends in block B999.

And, in some embodiments of block B999, the console 100 sends the recorded sensor measurements (e.g., a log of the sensor measurements) to another device.

Additionally, in blocks B910-B995, the console 100 may indicate the maintenance settings or the status of the maintenance operations on one or more output devices 101 (e.g., display devices 102, light bulbs 103, meters 104).

FIG. 10A illustrates an example embodiment of an operational flow for performing an electrical test on a printhead. The flow starts in block B1000 and then moves to block B1005, where a console 100 records the current usage of a printhead 210 when none of the printhead's nozzles are firing. Next, in block B1010, the console 100 records the voltage of a printhead 210 when none of the printhead's nozzles are firing. Then, in block B1015, the console 100 records the current usage of the printhead 210 when all of the printhead's nozzles are simultaneously activated. And, in block B1020, the console 100 records the voltage of a printhead 210 when all of the printhead's nozzles are simultaneously activated. Finally, the flow ends in block B1025.

FIG. 10B illustrates an example embodiment of an operational flow for obtaining baseline measurements of a printhead. The flow starts in block B1030 and then moves to block B1035, where a console 100 sets a delay time to a starting value. The flow then splits into a first flow and a second flow. The first flow moves to block B1040, where the console 100 controls a printhead 210 to activate the nozzles of the printhead 210 according to the delay time. The second flow moves to block B1045, where the console 100 records the current usage and the voltage of the printhead 210 while the nozzles of the printhead are activated. Also, the sampling rate in block B1045 may be high enough to allow the console 100 to record multiple samples of the current usage and the voltage between the beginnings of consecutive activations of the nozzles. For example, in some embodiments the sampling rate is 1 μs, 2 μs, or 3 μs, and the delay time is 10 μs to 30 μs.

The first flow then rejoins the second flow in block B1050, where the console 100 determines whether to continue activating the nozzles with the set delay. For example, the console 100 may determine to continue activating the nozzles with the set delay if the count of the nozzle activations at the set delay has not reached a threshold or if the nozzle activations at the set delay have not been performed for a predetermined amount of time. If the console 100 determines to continue activating the nozzles with the set delay (B1050=Yes), then the flow splits into the first flow and the second flow, which, respectively, return to blocks B1040 and B1045. If the console 100 determines not to continue activating the nozzles with the set delay (B1050=No), then the flow proceeds to block B1055.

In block B1055, the console 100 determines whether to change the delay time. For example, the console 100 may determine to change the delay time if the delay time has not yet been set to each delay time in a series of delay times. For example, the series of delay times may include a plurality of delay times that decrease from the beginning to the end of the series, or the series of delay times may include a plurality of delay times that increase from the beginning to the end of the series. And some example embodiments of series of delay times include 2, 3, 4, 5, 6, 7, 8, 9, 10, or more than 10 delay times. In one example embodiment, the series includes the following three delay times: 30 μs, 20 μs, and 10 μs.

If the console 100 determines to change the delay time (B1055=Yes), then the flow moves to block B1060, where the console 100 changes the delay time (e.g., changes the delay time to the next delay time in a series of delay times). Then the flow splits into the first flow and the second flow, which, respectively, return to blocks B1040 and B1045.

If the console 100 determines not to change the delay time (B1055=No), then the flow moves to block B1065, where the console 100 determines whether to repeat the previous operations. For example, the console 100 may determine to repeat the previous operations if they have not been repeated a predetermined number of times (e.g., 3 times, 4 times, 5 times). Repeating the previous operations allows the console 100 to confirm that the recorded current usage and voltage have minimum fluctuations and confirm that the results (e.g., the current usage and the voltages) of the previous operations are repeatable.

If the console 100 determines to repeat the previous operations, then the flow advances to block B1070, where the console 100 resets the delay time to the starting value (and, in some embodiments, resets an index in a series of delay times to the beginning). The flow then splits into the first flow and the second flow, which, respectively, return to blocks B1040 and B1045.

If the console 100 determines not to repeat the previous operations, then the flow ends in block B1075. The recorded current usage and voltages of the printhead 210 can constitute baseline measurements of the printhead 210.

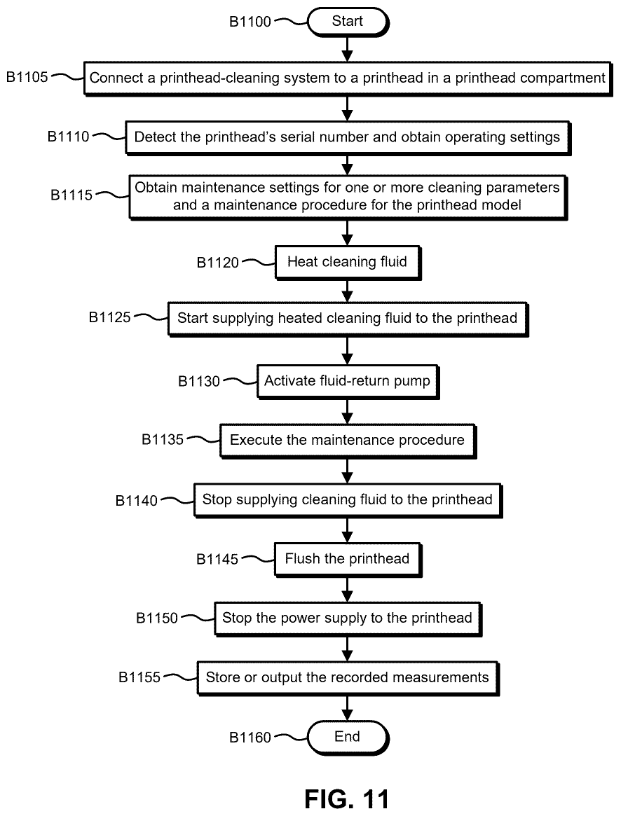

FIG. 11 illustrates an example embodiment of an operational flow for performing maintenance on a printhead. The flow starts in block B1100 and then moves to block B1105, where a user connects a printhead-cleaning system 10 to a printhead 210 while the printhead 210 is installed in a printhead compartment 202 of a printer 200. Block B1105 includes connecting one or more fluid-supply conduits 111 to the printhead 210, positioning a fluid collector 170 under the printhead 210, and connecting one or more printhead-communication cables 182 to the printhead 210.

Next, in block B1110, the console 100 detects and records the printhead's serial number and the printhead's total time of operation (e.g., total hours of operation) via one or more controller-communication cables 114, a printhead-control device 180, and the one or more printhead-communication cables 182. And the console 100 may use the serial number to detect the model of the printhead 210. The console 100 then obtains operating settings (e.g., as described in block B910 in FIG. 9) for the detected printhead 210, for example from user entry, from internal storage, or from another computing device. Then, in block B1115, the console 100 obtains maintenance settings for one or more cleaning parameters (e.g., as described in block B820 in FIG. 8) and obtains a maintenance procedure for the printhead 210 (e.g., for the model of the printhead 210). The one or more maintenance settings and the maintenance procedure may be obtained from user entry, from internal storage, or from another computing device.

The flow then proceeds to block B1120, where the console 100 heats cleaning fluid. And, in block B1125, the console 100 starts to supply heated cleaning fluid to the printhead 210. Also, in block B1130, the console 100 activates a fluid-return pump.

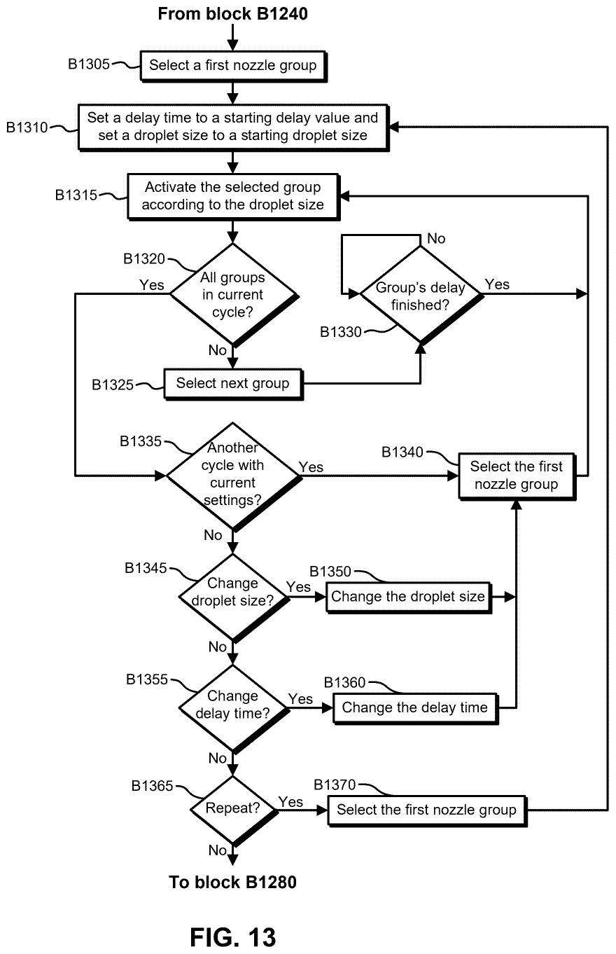

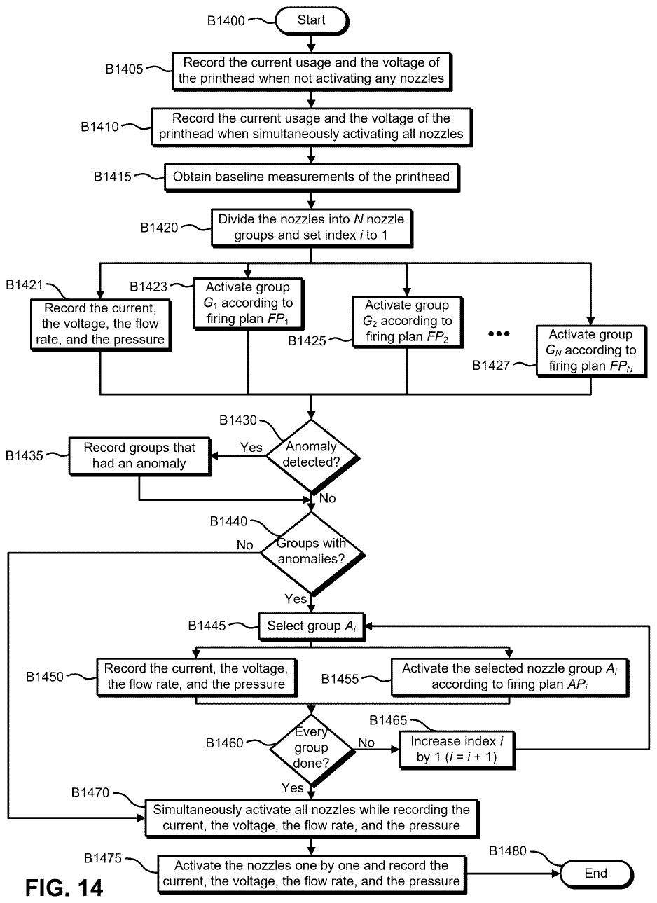

The flow then moves to block B1135, where the console 100 executes a maintenance procedure, for example as described in FIG. 12, FIG. 13, or FIG. 14.

Next, in block B1140, the console 100 stops supplying cleaning fluid to the printhead 210, and in block B1145 the console 100 flushes the printhead 210 (e.g., by activating the nozzles of the printhead 210 while supplying ink or storage fluid via the fluid-input port 148, which expels any remaining cleaning fluid). Then, in block B1150, the console 100 stops the power supply to the printhead. The flow then moves to block B1155, where the console 100 stores or outputs the recorded measurements that were acquired during the maintenance procedure. Finally, the flow ends in block B1160.

FIG. 12 illustrates an example embodiment of an operational flow for executing a maintenance procedure on a printhead. The flow starts in block B1200 and then moves to block B1205, where a console 100 records the current usage and voltage of a printhead 210 when no nozzles are being activated. Next, in block B1210, the console 100 records the current usage and voltage of the printhead 210 when all nozzles are being simultaneously activated.

The flow then moves to block B1215, where the console 100 determines whether the voltage is sufficiently stable. For example, the voltage may be sufficiently stable if the voltage of the printhead when all of the nozzles were being simultaneously activated is within 0.5 mV (+/−0.5 mV), 1 mV (+/−1 mV), within 2 mV (+/- 2 mV), or within 3 mV (+/—3 mV) of the voltage of the printhead when none of the nozzles were being activated.

If the console 100 determines that the voltage is not sufficiently stable (B1215=No), then the flow moves to block B1217, where the console 100 generates an error notification and outputs the error notification, for example on an output device 101. And the flow ends in block B1220.

If the console 100 determines that the voltage is sufficiently stable (B1215=Yes), then the flow splits into a first flow and a second flow.

The first flow then moves to block B1270, where the console 100 records at least some of the following: the current that is supplied to the printhead 210 (e.g., current over time), the voltage of the printhead 210 (e.g., voltage over time), the flow rate of the cleaning fluid that is supplied to the printhead 210 (e.g., the flow rate over time), the pressure of the cleaning fluid that is supplied to the printhead 210 (e.g., the pressure over time), the time spent cleaning the printhead 210, the amount of time that nozzles of the printhead 210 are firing, the maintenance procedure used, the voltages of the console 100, the temperature of the fluid heater 139, the temperature of the printhead 210, the pressure in the nozzles, the current used to activate the nozzles, and the readings of any other sensors (e.g., the fluid-collection sensor 132, the fluid-supply sensor 136, the temperature sensor 140, the fluid-level sensor 172 in the fluid collector 170). The first flow then moves to block B1275, where the console 100 determines whether the maintenance procedure is finished (e.g., whether the second flow has moved to block B1280). If the console 100 determines that the maintenance procedure is not finished (B1275=No), then the first flow returns to block B1270. Thus, the console 100 performs block B1270 while blocks B1230-B1267 are performed. If the console 100 determines that the maintenance procedure is finished (B1275=Yes), then the first flow ends in block B1280.

From block B1215, the second flow moves to block B1225, where the console 100 selects a first nozzle. Next, in block B1230, the console 100 activates only the selected nozzle (i.e., no nozzle other than the selected nozzle is activated). The selected nozzle may be activated multiple times, and the delay between activations may vary. While block B1230 is performed, in block B1270 the console 100 also records the current that is used to activate the selected nozzle and records the pressure in the selected nozzle (as well as other measurements, for example as described in block B865 in FIG. 8). To accurately determine the pressure in the selected nozzle, the console 100 supplies a constant voltage to the printhead 210 (e.g., a voltage that does not vary by more than a threshold, such as one microvolt), which divides the supplied voltage in the respective voltage of each piezo-electric actuator or heater element.

The second flow then moves to block B1232, where the console 100 determines whether every nozzle has been selected. If the console 100 determines that every nozzle has not been selected (B1232=No), then the second flow moves to block B1234, where the console 100 selects the next nozzle, and then the second flow returns to block B1230. If the console 100 determines that every nozzle has been selected (B1232=Yes), then the second flow moves to block B1235.

In block B1235, the console 100 generates a nozzle map (e.g., a nozzle matrix). The nozzle map indicates the following for each nozzle: the location of the nozzle, the current that was used to activate the nozzle in block B1230, and the pressure of the nozzle while the nozzle was being activated in block B1230. A nozzle that had a high current and a high pressure in block B1230 may be a nozzle that is struggling to activate (e.g., a piezo that is struggling to pulse), which may be an indicator of a blockage.

Next, in block B1240, the console 100 divides the nozzles into two or more nozzle groups based on the nozzle map. For example, the nozzles may be grouped such that nozzles with similar currents and pressures in block B1230 are grouped together. For example, the nozzles that that had the highest currents and pressures in block B1230 may be grouped together. The sizes of the nozzle groups may increase as the current and pressures decrease. For example, the group of nozzles that that had the highest currents and pressures in block B1230 may be the smallest group.

The nozzle groups may also be selected according to other criteria. For example, the nozzle groups may be selected based on location such that all nozzles within an area are grouped together or such that all nozzles in a row are grouped together.

Furthermore, as described in FIG. 14, the nozzle groups may have different firing plans. For example, the firing plan for the group of nozzles that that had the highest currents and pressures in block B1230 may be more intense (e.g., more firings, less delay time between firings, longer time, hotter cleaning fluid, higher cleaning-fluid pressure, different frequencies of activation pulses) than the firing plans of the other nozzle groups. For example, if the frequency of an activation pulse (nozzle-activation frequency) is normally 40 Khz, then the firing plan may include activation pulses that change according to the following sequence of frequencies: 35 Khz, 40 Khz, 45 Khz, 35 Khz, 40 Khz, and 45 Khz.

The second flow then moves to block B1245, where the console 100 selects a first nozzle group. Next, in block B1250, the console 100 sets a delay time to a starting delay value and sets a droplet size to a starting droplet size. The second flow then advances to block B1251, where the console 100 activates the selected nozzle group according to the set delay time and the set droplet size. For example, the console 100 may perform a predetermined number of activations, or the console 100 may perform the activations for a predetermined period of time.

The second flow then proceeds to block B1253, where the console 100 determines whether to change the delay time. For example, the console 100 may determine to change the delay time to the next delay time in series of delay times if every delay time in the series has not been set. If the console 100 determines to change the delay time (B1253=Yes), then the second flow moves to block B1255, where the console 100 changes the delay time (e.g., changes the delay time to the next delay time in a series of delay times), and then the second flow returns to block B1251.

If the console 100 determines not to change the delay time (B1253=No), then the second flow moves to block B1257. In block B1257, the console 100 determines whether to change the droplet size. For example, the console 100 may determine to change the droplet size to the next droplet size in series of droplet sizes if every droplet size in the series has not been set. If the console 100 determines to change the droplet size (B1257=Yes), then the second flow proceeds to block B1259, where the console 100 changes the set droplet size to a new droplet size, and the second flow then returns to block B1251. Also, if the printhead is not capable of producing more than one droplet size, blocks B1257-B1259 are omitted. If the console 100 determines not to change the droplet size (B1257=No), then the second flow moves to block B1260.

Accordingly, in the iterations of blocks B1251-B1259, the console 100 may activate the nozzles when various combinations of delay times and droplet sizes are set. For example, the console 100 may perform block B1251 according to each delay time in a series of delay times, and for each delay time, may perform block B1251 for each droplet size in a series of droplet sizes. For example, if there are 5 delay times in a series of delay times and 3 droplet sizes in a series of droplet sizes, then console may perform block B1251 according to 15 different combinations of delay times and droplet sizes.

Furthermore, the console 100 may set a delay time and vary the droplet size while that delay time is set before setting a different delay time and then varying the droplet size while the different delay time is set. Or the console 100 may set a droplet size and vary the delay time while that droplet size is set before setting a different droplet size and then varying the delay time while the different droplet size is set. Thus, in block B1255 the console 100 may change the delay time back to the starting delay time, and in block 1259 the console may change the droplet size back to the starting droplet size.

In block B1260, the console 100 determines whether to perform blocks B1250-B1259 for another nozzle group. For example, the console 100 may determine whether blocks B1250-B1259 have been performed for every nozzle group in a series of nozzle groups that begins with the first nozzle group. If the console 100 determines to perform blocks B1250-B1259 for another nozzle group (B1260=Yes), then the second flow moves to block B1262, where the console 100 selects another nozzle group (e.g., the next group in a series of groups), and then the second flow returns to block B1250.

Also, the console 100 may perform block B1260 before block B1253. Thus, the console 100 may perform block B1251 on each nozzle group while a particular combination of delay time and droplet size is set before changing either the delay time or the droplet size and then performing block B1251 again for each nozzle group. This decreases the duty cycle of a nozzle group during cleaning because the nozzles have fewer activations before another nozzle group is selected.

Also, in some embodiments, blocks B1251-B1259 are performed in parallel for each nozzle group, although the timings of the blocks are staggered. For example, if the console 100 selects 4 nozzle groups, then, while a particular delay time and droplet size are set, the console 100 may activate the first nozzle group and then, during the delay time for the first nozzle group, activate the second nozzle group, then the third nozzle group, and then the fourth nozzle group (always activating a nozzle group during the delay times of the other nozzle groups). Thus, each nozzle group may be activated during the delay times of the other nozzle groups.

If the console 100 determines not to perform blocks B1250-B1259 for another nozzle group (B1260=No), then the second flow moves to block B1265.

In block B1265, the console 100 determines whether to perform blocks B1250-B1259 again for each nozzle group. For example, the console 100 may perform multiple iterations of blocks B1250-B1259 for each nozzle group. And the pause between iterations (during which blocks B1250-B1259 are performed for other groups) may prevent the nozzles in a nozzle group from being damaged.

If the console 100 determines to perform blocks B1250-B1259 again for each nozzle group (B1265=Yes), then the second flow moves to block B1267, where the console 100 selects the first nozzle group, and the second flow then returns to block B1250. If the console 100 determines not to perform blocks B1250-B1259 again for each nozzle group (B1265=No), then the second flow ends in block B1280.

FIG. 13 illustrates an example embodiment of an operational flow that can replace blocks B1245-B1267 in FIG. 12. The second flow from block B1240 in FIG. 12 moves to block B1305, where a console 100 selects a first nozzle group in a series of nozzle groups. Next, in block B1310, the console 100 sets a delay time to a starting delay value and sets a droplet size to a starting droplet size. The second flow then moves to block B1315, where the console 100 activates the selected nozzle group according to the droplet size.

The second flow then proceeds to block B1320, where the console 100 determines whether all of the nozzle groups have been activated in the current cycle through the nozzle groups, where each nozzle group is activated only one time in one cycle through the nozzle groups. If all of the nozzle groups have not been activated in the current cycle (B1320=No), then the second flow moves to block B1325, where the console selects the next nozzle group, and then the second flow moves to block B1330.

In block B1330, the console 100 determines whether the delay for the selected nozzle group is finished. The first time that block B1330 is performed for a nozzle group, the console 100 may stagger the activations of the nozzle groups across the timespan of the set delay time. For example, the console 100 may calculate the delay of a nozzle group as follows. First, the set delay time is divided by the number of nozzle groups. Second, the calculation result is added to the time from which the immediately preceding nozzle group was activated. Thus, in the first cycle through the nozzle groups, the activations of the nozzle groups may equally spaced across the timespan of the set delay time.

If the console 100 determines that the delay for the selected nozzle group is not finished (B1330=No), then the second flow waits at block B1330. If the console 100 determines that the delay for the selected nozzle group is finished (B1330=Yes), then the second flow moves to block B1315.

If in block B1320 the console determines that all of the nozzle groups have been activated in the current cycle (B1320=Yes), then the second flow advances to block B1335. In block B1335, the console 100 determines whether to perform another cycle with the current settings. For example, the console 100 may determine to perform another cycle if the number of cycles that have been performed with the current settings has not reached a threshold value or if the cycles that have been performed with the current settings have not been performed for a specified period of time. If the console 100 determines to perform another cycle with the current settings (B1335=Yes), then the second flow proceeds to block B1340, where the console 100 selects the first nozzle group, and then the flow returns to block B1315.

If the console 100 determines not to perform another cycle with the current settings (B1335=No), then the second flow advances to block B1345.

In block B1345, the console 100 determines whether to change the droplet size. If the console 100 determines to change the droplet size (B1345=Yes), then the second flow proceeds to block B1350, where the console 100 changes the set droplet size to a new droplet size, and the second flow then moves to block B1340. Also, if the printhead is not capable of producing more than one droplet size, blocks B1345-B1350 are omitted. If the console 100 determines not to change the droplet size (B1345=No), then the second flow moves to block B1355.

In block B1355, the console 100 determines whether to change the delay time. If the console 100 determines to change the delay time (B1355=Yes), then the second flow moves to block B1360, where the console 100 changes the delay time (e.g., changes the delay time to the next delay time in a series of delay times), and then the second flow proceeds to block B1340. If the console 100 determines not to change the delay time (B1355=No), then the second flow moves to block B1365.

In block B1365, the console 100 determines whether to repeat the nozzle-activation sequence that was performed in blocks B1305-B1360. For example, the console 100 may determine whether the nozzle-activation sequence has been performed a specified number of times. If the console 100 determines to repeat the nozzle-activation sequence that was performed in blocks B1305-B1360 (B1365=Yes), then the second flow proceeds to block B1370, where the console 100 selects the first nozzle group, and the second flow then returns to block B1310.

If the console 100 determines not to repeat the cleaning sequence that was performed in blocks B1305-B1360 (B1365=No), then the second flow proceeds to block B1280 in FIG. 12, where the second flow ends.

FIG. 14 illustrates an example embodiment of an operational flow for executing a maintenance procedure on a printhead. The flow starts in block B1400 and then moves to block B1405, where a console 100 records the current usage and voltage of a printhead 210 when none of the nozzles of the printhead 210 are being activated. Then, in block B1410, the console 100 records the current usage and voltage of the printhead 210 when all of the nozzles of the printhead 210 are being simultaneously activated. Next, in block B1415, the console 100 obtains baseline measurements of the printhead 210, for example as described in FIG. 10B.

The flow then moves to block B1420, where the console 100 divides the nozzles into N nozzle groups and sets index i to 1. For example, the console 100 may divide the nozzles into N nozzle groups as described in blocks B1225-B1240 in FIG. 12 or based at least in part on the baseline measurements of the printhead 210. The set of nozzle groups SG (set SG) is constituted by the N nozzle groups G (SG={G₁, G₂, . . . , G_{N}}). The flow then splits into N+1 flows. One flow moves to block B1421, where the console 100 records measurements of the sensors in the printhead-cleaning system 10 and the printhead temperature, for example as described in block B865 in FIG. 8.

In each of the other N flows, three of which are illustrated in FIG. 14, the console 100 activates the nozzles in a respective nozzle group Gₓ according to a respective firing plan FPₓ of the nozzle group Gₓ. Thus, in FIG. 14, one flow moves to block B1423, one flow moves to block B1425, and another flow moves to block B1427.

The firing plan may indicate at least the following: a sequence of delay times, a sequence of droplet sizes, a sequence of nozzle-activation frequencies, a respective time spent activating the nozzles for each combination of a delay time and a droplet size, a sequence of nozzle-activation currents, and a number of repetitions of the various sequences. In some embodiments, the firing plans FP are all identical. However, in some embodiments, at least some of the firing plans FP are different from each other. For example, in some embodiments firing plan FP₁ is identical to firing plan FP₂, and in some embodiments, firing plan FP₁ is different from firing plan FP₂.

Also, the console 100 may stagger the activations of the nozzles in the nozzle groups G such that all of the nozzle groups G are not activated simultaneously. For example, if all of the firing plans FP are identical, then the console 100 may stagger the activations across the currently set delay time such that the delays between the activations of the nozzle groups G are identical. If all of the firing plans FP are not identical, then the console 100 may adjust the activations of one or more nozzle groups G to prevent more than a threshold number of nozzle groups G from being simultaneously activated.

Thus, in block B1421, the console 100 may acquire, for each nozzle group Gₓ, respective measurements (e.g., as described in block B865 in FIG. 8), such as measurements that indicate the current that is supplied to the nozzles, the voltage of the printhead 210, the flow rate of the cleaning fluid that is supplied to the nozzles, and the pressure of the cleaning fluid that is supplied to the nozzles, while only the nozzle group is activated.

After the console 100 has finished activating the all the nozzle groups G in the set SG according to their respective firing plans FP, the N+1 flows rejoin each other and move to block B1430. In block B1430, the console 100 determines whether anomalies were detected for any nozzle groups based on the measurements that were recorded in block B1421 and on the baseline measurements that were obtained in block B1415. For example, to determine whether a nozzle group Gₓ had an anomaly, the console 100 may evaluate the measurements from block B1421 that were acquired within a respective window of time around each activation of nozzle group Gₓ based on the baseline measurements. Also for example, the console 100 may compare the measurements that were obtained when the different nozzle groups G were being activated. For example, in some embodiments, the console determines whether the flow rates of the nozzle groups G were within a threshold (e.g., one standard deviation, −/+1 pL, −/+2 pL, −/+3 pL,) of an average or a median of all the flow rates of all the nozzle groups G, and determines that any nozzle group Gₓ that has a flow rate that is outside the threshold had an anomaly.

If the console 100 determines that respective anomalies were detected for one or more nozzle groups G (B1430=Yes), then the flow moves to block B1435.

In block B1435, the console records nozzle groups G that had an anomaly, for example by adding the nozzle groups G that had an anomaly to a list or adding a notation to the console's record of the nozzle groups G. The set of nozzle groups that have anomalies SA (set SA) thus includes the nozzle groups G that were recorded as having an anomaly, and the nozzle groups G that were recorded as having an anomaly are indicated by A to simplify the following description. Accordingly, set SA={A₁, A₂, . . . , A_{C}}, where C is the number of nozzle groups that were recorded as having an anomaly. Consequently, each nozzle group that has an anomaly can be indicated by both a corresponding A_{y} and a corresponding Gₓ (where y is the group's index in the set SG and x is the group's index in the set G).

The flow then moves to block B1440. Additionally, blocks B1430-B1435 can be performed concurrently with blocks B1421, B1423, B1425, and B1427. Thus, as the nozzle groups are being activated, the console 100 can detect anomalies in the nozzle groups.

Also, if the console 100 determines that no anomalies were detected (B1430=No), then the flow moves to block B1440.

In block B1440, the console 100 determines whether any nozzle group has been recorded as having an anomaly. If the console 100 determines that no nozzle group has been recorded as having an anomaly (B1440=No), then the flow proceeds to block B1470. If the console 100 determines that at least one nozzle group has been recorded as having an anomaly (B1440=Yes), then the flow moves to block B1445.

In block B1445, the console selects anomaly nozzle group Aᵢ.

The flow then splits into two flows, one of which proceeds to block B1450, and the other of which proceeds to block B1455, which are performed concurrently. In block B1450, the console 100 records at least the following: the current that is supplied to the nozzles, the voltage of the printhead 210, the flow rate of the cleaning fluid that is supplied to the nozzles, the pressure of the cleaning fluid that is supplied to the nozzles, and the temperature of the printhead 210. In block B1455, the console 100 activates the selected nozzle group Aᵢ according to firing plan APᵢ. Firing plan APᵢ may be different from the corresponding firing plan FP of the selected group APᵢ. For example, firing plan APᵢ may have a longer duration, shorter delay times, an increased activation current (which increases the pressure in the activated nozzles), or a different activating waveform. Also, all of the firing plans AP for nozzle groups that have anomalies SA may be identical, or at least some of them may be different from each other.

The flows then join together at block B1460, where the console 100 determines whether block B1455 has been performed for every nozzle group that was recorded as having an anomaly (e.g., whether i=C). If the console 100 determines that block B1455 has not been performed for every nozzle group that was recorded as having an anomaly (B1460=No), then the flow moves to block B1465, where the console increases index i by one, and the flow returns to block B1445. If the console 100 determines that block B1455 has been performed for every nozzle group that was recorded as having an anomaly (B1460=Yes), then the flow advances to block B1470.

In block B1470, the console 100 simultaneously activates all of the nozzles while recording the current that is supplied to the printhead 210, the voltage of the printhead 210, the flow rate of the cleaning fluid that is supplied to the printhead 210, and the pressure of the cleaning fluid that is supplied to the printhead 210 (and the console 100 may also record other measurements, for example as described in block B865 in FIG. 8). Thus, in block B1470, the console 100 acquires measurements that indicate the current that is supplied to the printhead 210, the voltage of the printhead 210, the flow rate of the cleaning fluid that is supplied to the printhead 210, and the pressure of the cleaning fluid that is supplied to the printhead 210 while all the nozzles are simultaneously activated.

Then, in block B1475, the console 100 activates all of the nozzles one-by-one (i.e., no more than one nozzle is activated at any specified time) while recording the current that is supplied to the printhead 210, the voltage of the printhead 210, the flow rate of the cleaning fluid that is supplied to the printhead 210, and the pressure of the cleaning fluid that is supplied to the printhead 210 (and the console 100 may also record other measurements, for example as described in block B865 in FIG. 8). Thus, in block B1475, the console 100 acquires, for each nozzle, respective measurements that indicate the current that is supplied to the nozzle, the voltage of the printhead 210, the flow rate of the cleaning fluid that is supplied to the nozzle, and the pressure of the cleaning fluid that is supplied to the nozzle while only the nozzle is activated.

The flow then ends in block B1480. Also, the console 100 may store or output any recorded measurements.

FIG. 15 is a schematic illustration of an example embodiment of a console-control device. The console-control device 120 includes one or more processors 121, one or more I/O components 122, and storage 123. Also, the hardware components of the console-control device 120 communicate via one or more buses 124 or other electrical connections. Examples of buses 124 include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 121 include one or more central processing units (CPUs), which include microprocessors (e.g., a single core microprocessor, a multi-core microprocessor); one or more graphics processing units (GPUs); one or more application-specific integrated circuits (ASICs); one or more field-programmable-gate arrays (FPGAs); one or more digital signal processors (DSPs); or other electronic circuitry (e.g., other integrated circuits). And the one or more processors 121 are an example of a processing unit.

The I/O components 122 include communication components (e.g., a GPU, a network-interface controller) that enable communication with other members of the console 100 (e.g., one or more output devices 101, one or more input devices 105, a fluid-collection reservoir 131, a fluid-collection sensor 132, a collection filter 133, a transfer valve 134, a fluid-supply reservoir 135, a fluid-supply sensor 136, a supply filter 137, two fluid pumps 138 (a fluid-supply pump 138A and a fluid-return pump 138B), a fluid heater 139, a temperature sensor 140, a pressure sensor 141, a supply valve 142, an air compressor 143, a flow sensor 144, an ammeter 145, a voltmeter 146, a system interface 147, and a fluid-port valve 149), with a fluid-level sensor 172, with a printhead-control device 180, with a printhead 210 (via the printhead-control device 180), with other computing devices 300, and with other input or output devices (not illustrated), which may include a network device, a keyboard, a mouse, a printing device, a display device, a light pen, an optical-storage device, a scanner, a microphone, a drive, a joystick, and a control pad.

The I/O components 122 enable the console-control device 120 to wirelessly communicate with a first computing device 300A (e.g., a tablet, a smartphone) or a second computing device 300B (e.g., a laptop). The wireless communication may use, for example, one or more of the following: a near-field-communication standard, a Bluetooth standard, and an IEEE 802.11 standard. Also, in some embodiments, the I/O components 122 enable the console-control device 120 communicate with the first computing device 300A or the second computing device 300B via wired communication (e.g., according to an IEEE 802.3 standard).

The storage 123 includes one or more computer-readable storage media. As used herein, a computer-readable storage medium is a computer-readable medium that includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 123, which may include both ROM and RAM, can store computer-readable data or computer-executable instructions. Furthermore, in embodiments where the storage 123 includes RAM, the one or more processors 121 can use the RAM as a work area. Also, the storage 123 is an example of a storage unit. Additionally, when the console 100 or the console-control device 120 is described as obtaining, recording, generating, or storing information (e.g., operating settings, maintenance settings, measurements, firing plans), the information is stored in the storage 123. For example, the storage 123 in FIG. 15 includes a measurement repository 1236, which is where obtained sensor measurements are recorded.

The console-control device 120 additionally includes a communication module 1231, a setting-acquisition module 1232, an electrical-testing module 1233, a supply-control module 1234, and a printhead-control module 1235. A module includes logic, computer-readable data, or computer-executable instructions. In the embodiment shown in FIG. 15, the modules are implemented in software (e.g., Assembly, C, C++, C #, Java, BASIC, Perl, Visual Basic, Python). However, in some embodiments, the modules are implemented in hardware (e.g., customized circuitry) or, alternatively, a combination of software and hardware. When the modules are implemented, at least in part, in software, then the software can be stored in the storage 123. Also, in some embodiments, the console-control device 120 includes additional or fewer modules, the modules are combined into fewer modules, or the modules are divided into more modules.

The communication module 1231 includes instructions that cause the applicable components (e.g., the one or more processors 121, the I/O components 122, the storage 123) of the console-control device 120 to communicate with one or more other devices, such as other computing devices (e.g., the computing devices 300), and to communicate with the output devices 101, which may include generating user interfaces for display on a display device 102 or indicating the status of maintenance operations on one or more output devices 101 (e.g., display devices 102, light bulbs 103, meters 104). For example, some embodiments of the communication module 1231 include instructions that cause the applicable components of the console-control device 120 to perform at least some of the operations that are described in block B927 in FIG. 9, in block B1155 in FIG. 11, and in block B1217 in FIG. 12. And the applicable components operating according to the communication module 1231 realize an example of a communication unit.

The setting-acquisition module 1232 includes instructions that cause the applicable components (e.g., the one or more processors 121, the I/O components 122, the storage 123) of the console-control device 120 to detect a printhead model, to obtain operating settings for a printhead (e.g., from the storage 123, from another computing device 300, from an input device 105), to obtain maintenance settings (e.g., from the storage 123, from another computing device 300, from an input device 105), to set maintenance settings, or to obtain maintenance procedures (e.g., from the storage 123, from another computing device 300, from an input device 105), which may include one or more firing plans. For example, some embodiments of the setting-acquisition module 1232 include instructions that cause the applicable components of the console-control device 120 to control the console 100 to perform at least some of the operations that are described in blocks B820-B825 in FIG. 8, in blocks B910-915 in FIG. 9, and in blocks B1110-B1115 in FIG. 11. And the applicable components operating according to the setting-acquisition module 1232 realize an example of a setting-acquisition unit.

The electrical-testing module 1233 includes instructions that cause the applicable components (e.g., the one or more processors 121, the I/O components 122, the storage 123) of the console-control device 120 to control the console 100 to perform one or more electrical tests on a printhead 210, to obtain baseline measurements from a printhead 210, to record measurements from one or more sensors, or to monitor measurements from one or more sensors, which may include detecting anomalies based on the measurements. For example, some embodiments of the electrical-testing module 1233 include instructions that cause the applicable components of the console-control device 120 to control the console 100 to perform at least some of the operations that are described in blocks B540-B545 in FIG. 5; in blocks B865-B870 in FIG. 8; in blocks B920, B925, B930, B950, and B970-B985 in FIG. 9; in blocks B1005-B1020 in FIG. 10A; in block B1040 in FIG. 10B; in blocks B1205, B1210, B1270, and B1275 in FIG. 12; and in blocks B1405-B1415, B1421, B1430, B1435, B1450, B1470, and B1475 in FIG. 14. And the applicable components operating according to the electrical-testing module 1233 realize an example of an electrical-testing unit.

The supply-control module 1234 includes instructions that cause the applicable components (e.g., the one or more processors 121, the I/O components 122, the storage 123) of the console-control device 120 to control the applicable components (e.g., a fluid-supply pump 138A, a fluid-return pump 138B, a fluid heater 139, a supply valve 142, a fluid-port valve 149) of the console 100 to supply cleaning fluid or another fluid (e.g., ink, storage fluid) to a printhead 210 according to the settings and to recover cleaning fluid from the cleaning fluid collector 170. For example, some embodiments of the supply-control module 1234 include instructions that cause the applicable components of the console-control device 120 to control the applicable components of the console 100 to perform at least some of the operations that are described in block B420 in FIG. 4; in blocks B520, B522, B535, and B550 in FIG. 5; in blocks B830, B835, B837, B840, B855, and B860 in FIG. 8; in blocks B935, B940, B960, B965, and B990 in FIG. 9; and in blocks B1120, B1125, B1130, B1140, and B1145 in FIG. 11. The applicable components of the console-control device 120 operating according to the supply-control module 1234 realize an example of a supply-control unit.

The printhead-control module 1235 includes instructions that cause the applicable components (e.g., the one or more processors 121, the I/O components 122, the storage 123) of the console-control device 120 to control the applicable components of the console 100 and the printhead-control device 180 to supply power to and control a printhead 210, which may include activating one or more nozzles of the printhead 210 (e.g., according to one or more firing plans), or to divide the nozzles of a printhead 210 into nozzle groups. For example, some embodiments of the printhead-control module 1235 include instructions that cause the console-control device 120 to control the console 100 to perform at least some of the operations that are described in block B425 in FIG. 4; in blocks B525 and B550 in FIG. 5; in blocks B605-B635 in FIG. 6; in blocks B705-B755 in FIG. 7; in blocks B845-B850 in FIG. 8; in block B945 in FIG. 9; in blocks B1015 and B1020 in FIG. 10A; in blocks B1035-B1070 in FIG. 10B; in blocks B1210 and B1225-B1267 in FIG. 12; in blocks B1305-B1370 in FIG. 13; and in blocks B1410, B1420, B1423-B1427, B1445, and B1455-B1475 in FIG. 14. And the applicable components operating according to the printhead-control module 1235 realize an example of a printhead-control unit.

FIG. 16 is a schematic illustration of an example embodiment of the printhead-control device 180. The printhead-control device 180 includes a light bulb 181, a console interface 184, a power converter 185, one or more processors 186, storage 187, and a printhead interface 188.

The console interface 184 allows the one or more processors 186 to communicate with the console 100 via the controller-communication cables 114. The console interface 184 may include a network-interface controller. Also, the console interface 184 may use wireless communication to communicate with the console 100 in addition to, or in alternative to, the controller-communication cables 114.

The power converter 185 converts power that is supplied by the console 100 into power that is usable by the printhead-control device 180 or the printhead 210. For example, the power converter 185 may step down a supplied voltage from 28V to 24V or to 7V. And some of the power that is output by the power converter 185 may be supplied to the printhead 210 via one or more printhead-communication cables 182. Also, the printhead-control device 180 may include one or more batteries in addition to, or in alternative to, the power that is supplied from the console 100.

The printhead interface 188 allows the one or more processors 186 to communicate with the printhead 210 via the printhead-communication cables 182.

The electrical connectors 183 are configured to communicate with (e.g., send signals to, receive signals from) and supply power to the printhead 210. Each electrical connector 183 may be able to connect to multiple electrical lines (e.g., voltage-supply lines, data-transmission lines) of the printhead 210, which may allow the printhead-control device 180 to communicate with the printhead 210 via multiple electrical lines. For example, the electrical lines may allow the printhead-control device 180 to activate one or more nozzles of the printhead 210, supply power to the printhead 210, or to read the temperature of the printhead 210 (e.g., by reading signals from one or more thermocouples in the printhead 210).

Additionally, each of the electrical connectors 183 may be configured to connect with the wiring interface of one or more particular printhead models. For example, in FIG. 16, a first electrical connector 183A may be configured to connect to a ribbon cable of the model of the printhead 210. Other electrical connectors (e.g., a second electrical connector 183B) may be configured to connect with the wiring interfaces of other models of printheads. Also, some printheads include multiple wiring interfaces and can simultaneously connect with multiple electrical connectors 183. For example, in FIG. 16, the second electrical connector 183B may be configured to connect to a wiring set of the printhead 210. In some embodiments, the second electrical connector 183B supplies power to the printhead 210, and the first electrical connector 183A transmits signals (e.g., data) to, and receives signals from, the printhead 210.

The printhead-control device 180 additionally includes a console-communication module 1871 and a printhead-communication module 1872. In the embodiment shown in FIG. 16, the modules are implemented in software (e.g., Assembly, C, C++, C #, Java, BASIC, Perl, Visual Basic, Python). However, in some embodiments, the modules are implemented in hardware (e.g., customized circuitry) or, alternatively, a combination of software and hardware. When the modules are implemented, at least in part, in software, then the software can be stored in the storage 187. Also, in some embodiments, the printhead-control device 180 includes additional or fewer modules, the modules are combined into fewer modules, or the modules are divided into more modules.

The console-communication module 1871 includes instructions that cause the applicable components (e.g., the one or more processors 186, the console interface 184, the storage 187) of the printhead-control device 180 to communicate with the console 100, for example to receive signals that indicate that the printhead-control device 180 should activate one or more nozzles of a printhead, to receive signals that indicate that the printhead-control device 180 should deactivate one or more nozzles of a printhead, or to send printhead information (e.g., model, hours of operation, printhead temperature) to the console 100. For example, some embodiments of the console-communication module 1871 include instructions that cause the printhead-control device 180 to perform at least some of the operations that are described in block B425 in FIG. 4; in blocks B525 and B550 in FIG. 5; in blocks B605-B635 in FIG. 6; in blocks B705-B755 in FIG. 7; in blocks B845-B850 in FIG. 8; in block B945 in FIG. 9; in blocks B1015 and B1020 in FIG. 10A; in blocks B1035-B1070 in FIG. 10B; in blocks B1210 and B1225-B1267 in FIG. 12; in blocks B1305-B1370 in FIG. 13; and in blocks B1410, B1420, B1423-B1427, B1445, and B1455-B1475 in FIG. 14. And the applicable components operating according to the console-communication module 1871 realize an example of a console-communication unit.

The printhead-communication module 1872 includes instructions that cause the applicable components (e.g., the one or more processors 186, the console interface 184, the storage 187) of the printhead-control device 180 to communicate with a printhead, for example to activate one or more nozzles of a printhead or to retrieve information (e.g., model, hours of operation, temperature) from the printhead. For example, some embodiments of the printhead-communication module 1872 include instructions that cause the printhead-control device 180 to perform at least some of the operations that are described in block B425 in FIG. 4; in blocks B525 and B550 in FIG. 5; in blocks B605-B635 in FIG. 6; in blocks B705-B755 in FIG. 7; in blocks B845-B850 in FIG. 8; in block B945 in FIG. 9; in blocks B1015 and B1020 in FIG. 10A; in blocks B1035-B1070 in FIG. 10B; in blocks B1210 and B1225-B1267 in FIG. 12; in blocks B1305-B1370 in FIG. 13; and in blocks B1410, B1420, B1423-B1427, B1445, and B1455-B1475 in FIG. 14. And the applicable components operating according to the printhead-communication module 1872 realize an example of a printhead-communication unit.

Also, the console-control device 120 and the printhead-control device 180 can cooperate when performing operations that are described in block B425 in FIG. 4; in blocks B525 and B550 in FIG. 5; in blocks B605-B635 in FIG. 6; in blocks B705-B755 in FIG. 7; in blocks B845-B850 in FIG. 8; in block B945 in FIG. 9; in blocks B1015 and B1020 in FIG. 10A; in blocks B1035-B1070 in FIG. 10B; in blocks B1210 and B1225-B1267 in FIG. 12; in blocks B1305-B1370 in FIG. 13; and in blocks B1410, B1420, B1423-B1427, B1445, and B1455-B1475 in FIG. 14.

### DEFINITIONS

In the description, specific details are set forth in order to provide a thorough understanding of the embodiments disclosed. However, well-known methods, procedures, components and circuits may not have been described in detail in order to avoid unnecessarily lengthening the present disclosure.

Also, if a member (e.g., element, part, component) is referred herein as being “on,” “against,” “connected to,” or “coupled to” another member, then the member can be directly on, against, connected or coupled to the other member, but intervening members may also be present between the member and the other member. In contrast, if a member is referred to as being “directly on,” “directly against,” “directly connected to,” or “directly coupled to” another member, then there are no intervening members present between the member and the other member.

Furthermore, the terms “comprising,” “having,” “includes,” “including,” and “containing” are to be construed as open-ended terms unless otherwise noted. Accordingly, these terms, when used in the present specification, specify the presence of described features, integers, steps, operations, elements, materials, or members, but do not preclude the presence or addition of one or more other features, integers, steps, operations, elements, materials, or members that are not explicitly described.

What is claimed is:

1. A printhead-cleaning system comprising:
a cleaning-fluid-supply reservoir that is configured to store cleaning fluid;
one or more cleaning-fluid-supply conduits that are configured to connect to the cleaning-fluid-supply reservoir, connect to a printhead while the printhead is installed in a printer, and convey cleaning fluid from the console to the printhead while the printhead is installed in the printer, wherein the printhead includes a plurality of nozzles;
a first pump that is configured to supply cleaning fluid from the cleaning-fluid-supply reservoir to the one or more cleaning-fluid-supply conduits;
a cleaning-fluid-collection reservoir;
a fluid collector, wherein the fluid collector is detached from the cleaning-fluid-collection reservoir, is moveable independent of the cleaning-fluid-collection reservoir, and can be positioned below the printhead while the printhead is installed in the printer;
a cleaning-fluid return conduit that is configured to connect to the fluid collector and the cleaning-fluid-collection reservoir and that is configured to convey liquid from the fluid collector to the cleaning-fluid-collection reservoir;
one or more printhead-communication cables that are configured to connect to a printhead and supply electrical signals to the printhead while the printhead is installed in the printer;
one or more memories; and
one or more processors that are in communication with the one or more memories and that cooperate with the one or more memories to cause the printhead-cleaning system to perform operations including:
supplying cleaning fluid from the cleaning-fluid-supply reservoir, through the one or more cleaning-fluid-supply conduits, to the printhead while the printhead is installed in the printer, and
while supplying the cleaning fluid to the printhead, sending one or more signals to the printhead, through the one or more printhead-communication cables, to activate one or more nozzles of the plurality of nozzles of the printhead while the printhead is installed in the printer.

2. The printhead-cleaning system of claim 1, further comprising:
a second pump that is configured to convey cleaning fluid from the fluid collector through the cleaning-fluid return conduit to the cleaning-fluid-collection reservoir.

3. The printhead-cleaning system of claim 1,
wherein the cleaning-fluid-supply reservoir, the first pump, the cleaning-fluid-collection reservoir, the one or more memories, and the one or more processors are all housed in a body, and
wherein the fluid collector is detached from the body and is moveable independent of the body.

4. The printhead-cleaning system of claim 1, wherein to activate the one or more nozzles of the printhead, the one or more processors and the one or more memories further cooperate to cause the printhead-cleaning system to activate the one or more nozzles according to a firing plan,
wherein the firing plan varies at least one of the following over time: a delay time between nozzle activations, a droplet size, and a nozzle-activation frequency.

5. The printhead-cleaning system of claim 1, wherein to activate the one or more nozzles of the printhead, the one or more processors and the one or more memories further cooperate to cause the printhead-cleaning system to:
divide the plurality of nozzles into groups of nozzles, and
activate each group of the groups of nozzles according to at least one firing plan.

6. The printhead-cleaning system of claim 5, wherein each group of the groups of nozzles has a respective firing plan that is different from the firing plans of the other groups of nozzles.

7. The printhead-cleaning system of claim 5, wherein to divide the plurality of nozzles into groups of nozzles, the one or more processors and the one or more memories further cooperate to cause the printhead-cleaning system to:
activate each nozzle of the plurality of nozzles while no other nozzle of the plurality of nozzles is activated and while recording measurements from one or more sensors, wherein the measurements include nozzle-activation current or nozzle pressure; and
divide the plurality of nozzles into the groups of nozzles based on the measurements.

8. A method comprising:
positioning a fluid collector below a printhead while the printhead is installed in a printer, wherein the printhead includes a plurality of nozzles;
coupling one or more printhead-communication cables to the printhead while the printhead is installed in the printer;
coupling one or more fluid-supply conduits to the printhead while the printhead is installed in the printer; and
while the printhead is installed in the printer,
supplying cleaning fluid to the printhead via the one or more fluid-supply conduits, and
sending one or more signals to the printhead, through the one or more printhead-communication cables, to activate one or more nozzles of the plurality of nozzles of the printhead while supplying the cleaning fluid to the printhead,
wherein the one or more nozzles, when activated while cleaning fluid is supplied to the printhead, eject cleaning fluid into the fluid collector.

9. The method of claim 8, further comprising:
conveying cleaning fluid from the fluid collector to a fluid-collection reservoir.

10. The method of claim 8, further comprising:
heating the cleaning fluid, wherein the heated cleaning fluid is supplied to the printhead.

11. The method of claim 8, further comprising:
obtaining measurements from one or more sensors; and
analyzing the measurements for anomalies.

12. The method of claim 8, further comprising:
stopping the supply of cleaning fluid to the printhead; and
after stopping the supply of cleaning fluid to the printhead, supplying ink or storage fluid to the printhead via the one or more fluid-supply conduits.

13. The method of claim 8, wherein the one or more nozzles are activated according to at least one firing plan, wherein the firing plan varies at least one of the following over time: a delay time between nozzle activations, a droplet size, and a nozzle-activation frequency.

14. The method of claim 13, further comprising:
dividing the plurality of nozzles into groups of nozzles, and
activating each group of the groups of nozzles according to the at least one firing plan while no other group of the groups of nozzle is being activated.

15. The method of claim 14, wherein dividing the plurality of nozzles into groups of nozzles includes:
activating each nozzle of the plurality of nozzles while no other nozzle of the plurality of nozzles is activated and while recording measurements from one or more sensors, wherein the measurements include nozzle-activation currents or nozzle pressures; and
dividing the plurality of nozzles into the groups of nozzles based on the measurements.

16. The method of claim 15,
wherein the measurements include nozzle-activation currents and nozzle pressures,
wherein the groups of nozzles include different numbers of nozzles, and
wherein the nozzles in a smallest group of the groups of nozzles had nozzle-activation currents and nozzle pressures that were higher than the nozzle-activation currents and nozzle pressures of the nozzles in the other groups of nozzles.

17. The method of claim 16,
wherein the at least one firing plan includes two or more firing plans,
wherein the two or more firing plans include a respective firing plan for the smallest group that is different from the other firing plans of the two or more firing plans,
and wherein the respective firing plan for the smallest group includes one or more of the following: a delay time that is smaller than any delay time in the other firing plans, a nozzle pressure that is higher than any nozzle pressure in the other firing plans, a cleaning-fluid temperature that is higher than any cleaning-fluid temperature in the other firing plans, and a nozzle-activation frequency that is higher than any nozzle-activation frequency in the other firing plans.

18. A method comprising:
activating each nozzle of a plurality of nozzles of a printhead while no other nozzle of the plurality of nozzles is activated and while recording measurements from one or more sensors, wherein the measurements include nozzle-activation currents and nozzle pressures;
dividing the plurality of nozzles into groups of nozzles based on the measurements;
supplying cleaning fluid to a printhead that is installed in a printer; and
while supplying cleaning fluid to the printhead, activating each group of the groups of nozzles while no other group of the groups of nozzles is being activated.

19. The method of claim 18, further comprising:
after activating a first group of nozzles while supplying cleaning fluid to the printhead, of the groups of nozzles, changing a droplet size of the first group of nozzles; and
after changing the droplet size of the first group of nozzles, activating the first group of nozzles while supplying cleaning fluid to the printhead.

20. The method of claim 18,
wherein the groups of nozzles include different numbers of nozzles, and
wherein the nozzles in a smallest group of the groups of nozzles had nozzle-activation currents and nozzle pressures that were higher than the nozzle-activation currents and nozzle pressures of the nozzles in the other groups of nozzles.
